(19) United States
(12) Patent Application Publication
(10) Pub. No.: US 2009/0246675 A1
(43) Pub. Date: Oct. 1, 2009

(54) TWO-COMPONENT DEVELOPER, REPLENISHING DEVELOPER, AND IMAGE-FORMING METHOD USING THE DEVELOPERS

(75) Inventors: Kunihiko Nakamura, Gotemba-shi (JP); Hiroyuki Fujikawa, Yokohama-shi (JP); Nozomu Komatsu, Susono-shi (JP); Yoshinobu Baba, Yokohama-shi (JP); Takayuki Itakura, Mishima-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/394,839

(22) Filed: Feb. 27, 2009

Related U.S. Application Data
(63) Continuation-in-part of application No. 12/120,977, filed on May 15, 2008.

(30) Foreign Application Priority Data
Feb. 1, 2008 (JP) 2008-022658

(51) Int. Cl. G03G 9/083; G03G 13/20

(52) U.S. Cl. 430/111.31; 430/105; 430/124.1

(57) ABSTRACT

An object of the present invention is to suppress the adhesion of a carrier to an image bearing member and the generation of a flaw in the surface layer of the image bearing member, and to improve the dot reproducibility of an electrostatic latent image, and so on. The object is achieved by a two-component developer containing a magnetic carrier, which contains resin-containing magnetic particles, in which the packed bulk density ρ1 is 0.80 to 2.40 and ρ1/ρ2 (ρ2 represents true density) is 0.20 to 0.42 of the porous magnetic core particles, and a specific resistance of the porous magnetic core particles, an average breaking strength of the magnetic carrier and a toner surface tension constant in a 45-vol % aqueous solution of methanol measured by a capillary suction time method fall into the specific range, respectively.

### BACKGROUND OF THE INVENTION

1. Field of the Invention

This application is a continuation-in-part of application Ser. No. 12/120,977, filed on May 15, 2008, which is incorporated herein by reference.

The present invention relates to a two-component developer and a replenishing developer each of which is used in an electrophotographic system, an electrostatic recording system, or an electrostatic printing system, and an image-forming method using the two-component developer and the replenishing developer.

2. Description of the Related Art

Developing systems such as electrophotography are classified into a one-component developing system using toner alone and a two-component developing system using the mixture of a magnetic carrier and toner.

Because the magnetic carrier is used in the two-component developing system, the frequency at which the toner is subjected to triboelectric charging is large, so the charging property of the toner is stable as compared to that in the case of the one-component developing system, and the two-component developing system is advantageous for maintaining high image quality over a long time period. In addition, the two-component developing system is frequently used especially in a high-speed machine because the magnetic carrier has a high ability to feed the toner to a developing zone.

A resin-coated magnetic carrier having an average particle diameter of 25 to 55 μm and a specified intensity of magnetization (see JP 2002-91090 A) and a magnetic carrier having a volume magnetization of 20 to 60 emu/cm³ (see JP 09-281805 A) have been proposed as carriers.

In each of those proposals, the naps of a magnetic carrier on a developer carrying member are made dense so that dot reproducibility is improved, and excellent durability under a normal-temperature, normal-humidity (25° C./50% RH) environment is achieved. However, when images each having a relatively large image area (an image area of 50% or more) to be used in photographs or POD's are printed on a large number of sheets under a normal-temperature, low-humidity environment the image densities may reduce from on the way of printing of sheets as compared to the image density of the first sheet, so the magnetic carrier has been still susceptible to improvement.

In addition, a magnetic carrier obtained by incorporating a polymer into a porous magnetic carrier core (see JP 11-295933 A), and a magnetic carrier provided with a first coat layer in a porous magnetic carrier core and a second coat layer with which the first coat layer is further coated (see JP 2003-131436 A) have been proposed.

Each of the above magnetic carriers is excellent in triboelectric charging performance and charging stability, but may reduce the dot reproducibility of an electrostatic latent image or generate a flaw in the surface layer of an electrostatic latent image bearing member to reduce image quality when the carrier is used for a long time period, so each of the magnetic carriers has been still susceptible to improvement.

In addition, the following resin-coated magnetic carrier has been proposed (see JP 2004-77568 A): the carrier is obtained by incorporating a resin into a porous magnetic substance used as a magnetic carrier core material, and has a resistance LogR of 10.0 Ω·cm or more at the time of the application of 500V.

When the above resin-coated magnetic carrier is used, the carrier does not adhere to an image, and a white dot on an electrostatic latent image bearing member due to the breakdown of the magnetic carrier can be prevented. However, a reduction in density may occur at the rear end of a solid image portion, so the carrier has been still susceptible to improvement.

In view of the foregoing, a two-component developer containing a carrier has been desired, which can achieve an improvement in dot reproducibility, the prevention of a reduction in density at the rear end of a solid image, the prevention of a reduction in image density when the developer is used for a long time period, and the prevention of a flaw in the surface layer of an electrostatic latent image bearing member.

### SUMMARY OF THE INVENTION

An object of the present invention is to suppress the adhesion of a carrier to an electrostatic latent image bearing member, improve the dot reproducibility of an electrostatic latent image, suppress a reduction in density at the rear end of a solid image, suppress a reduction in image density when a developer is used for a long time period, and suppress the generation of a flaw in the surface layer of the electrostatic latent image bearing member.

Another object of the present invention is to suppress a reduction in image density when an image is left to stand under a high temperature and a high humidity.

The present invention provides a two-component developer, including a magnetic carrier and a toner, in which:

the magnetic carrier includes a carrier containing resin-containing magnetic particles obtained by incorporating a resin into pores of porous magnetic core particles;

when a packed bulk density and a true density of the porous magnetic core particles are represented by ρ1 (g/cm³) and ρ2 (g/cm³), respectively, ρ1 is 0.80 or more and 2.40 or less, and ρ1/ρ2 is 0.20 or more and 0.42 or less;

the porous magnetic core particles have a specific resistance of 1.0×10³ Ω·cm or more and 5.0×10⁷ Ω·cm or less;

when a 50% particle diameter (D50) on a volume basis of the magnetic carrier is represented by D50, an average breaking strength of the magnetic carrier having a particle diameter of (D50−5 μm) or more and (D50+5 μm) or less is represented by P1 (MPa), and an average breaking strength of the magnetic carrier having a particle diameter of 10 μm or more and less than 20 μm is represented by P2 (MPa), P1 is 20 or more and 100 or less, and P2/P1 is 0.50 or more and 1.10 or less;

the toner has toner particles each containing at least a binder resin and a wax; and

the toner has a toner surface tension constant in a 45-vol % aqueous solution of methanol measured by a capillary suction time method of 3.0×10⁻⁶ kN/m or more and 1.0×10⁻⁴ kN/m or less.

Further, the present invention provides a replenishing developer for use in an image-forming method which includes at least the steps of: charging an electrostatic latent image bearing member; forming an electrostatic latent image on a surface of the electrostatic latent image bearing member; developing the electrostatic latent image with a two-component developer in a developing device to form a toner image; transferring the toner image onto a transfer material through or without through an intermediate transfer body; and fixing the transferred toner image to the transfer material, and in which the developing device is replenished with the replenishing developer in accordance with a reduction in toner concentration of the two-component developer in the developing device, and an excess magnetic carrier in the developing device is discharged from the developing device, in which:

the replenishing developer including a magnetic carrier and a toner at a compounding ratio of 2 parts by mass or more and 50 parts by mass or less with respect to 1 part by mass of the magnetic carrier;

the magnetic carrier includes a carrier containing resin-containing magnetic particles obtained by incorporating a resin into pores of porous magnetic core particles;

when a packed bulk density and a true density of the porous magnetic core particles are represented by ρ1 (g/cm³) and ρ2 (g/cm³), respectively, ρ1 is 0.80 or more and 2.40 or less, and ρ1/ρ2 is 0.20 or more and 0.42 or less;

the porous magnetic core particles have a specific resistance of 1.0×10³ Ω·cm or more and 5.0×10⁷ Ω·cm or less;

when a 50% particle diameter (D50) on a volume basis of the magnetic carrier is represented by D50, an average breaking strength of the magnetic carrier having a particle diameter of (D50−5 μm) or more and (D50+5 μm) or less is represented by P1 (MPa), and an average breaking strength of the magnetic carrier having a particle diameter of 10 μm or more and less than 20 μm is represented by P2 (MPa), P1 is 20 or more and 100 or less, and P2/P1 is 0.50 or more and 1.10 or less;

the toner has toner particles each containing at least a binder resin and a wax; and

the toner has a toner surface tension constant in a 45-vol % aqueous solution of methanol measured by a capillary suction time method of 3.0×10⁻⁶ kN/m or more and 1.0×10⁻⁴ kN/m or less.

Further, the present invention provides an image-forming method, including at least the steps of: charging an electrostatic latent image bearing member; forming an electrostatic latent image on a surface of the electrostatic latent image bearing member; developing the electrostatic latent image with a two-component developer in a developing device to form a toner image; transferring the toner image onto a transfer material through or without through an intermediate transfer body; and fixing the transferred toner image to the transfer material, in which the developing device is replenished with a replenishing developer in accordance with a reduction in toner concentration of the two-component developer in the developing device, and an excess magnetic carrier in the developing device is discharged from the developing device, in which:

the two-component developer and the replenishing developer each include a developer containing a magnetic carrier and a toner;

the replenishing developer contains the toner at a compounding ratio of 2 parts by mass or more and 50 parts by mass or less with respect to 1 part by mass of the magnetic carrier;

the magnetic carrier includes a carrier containing resin-containing magnetic particles obtained by incorporating a resin into pores of porous magnetic core particles;

when a packed bulk density and a true density of the porous magnetic core particles are represented by ρ1 (g/cm³) and ρ2 (g/cm³), respectively, ρ1 is 0.80 or more and 2.40 or less, and ρ1/ρ2 is 0.20 or more and 0.42 or less;

the porous magnetic core particles have a specific resistance of 1.0×10³ Ω·cm or more and 5.0×10⁷ Ω·cm or less;

when a 50% particle diameter (D50) on a volume basis of the magnetic carrier is represented by D50, an average breaking strength of the magnetic carrier having a particle diameter of (D50−5 μm) or more and (D50+5 μm) or less is represented by P1 (MPa), and an average breaking strength of the magnetic carrier having a particle diameter of 10 μm or more and less than 20 μm is represented by P2 (MPa), P1 is 20 or more and 100 or less, and P2/P1 is 0.50 or more and 1.10 or less;

the toner has toner particles each containing at least a binder resin and a wax; and

the toner has a toner surface tension constant in a 45-vol % aqueous solution of methanol measured by a capillary suction time method of 3.0×10⁻⁶ kN/m or more and 1.0×10⁻⁴ kN/m or less.

According to the present invention, the adhesion of a carrier to an electrostatic latent image bearing member and the generation of a flaw in the member can be suppressed by using the developer of the present invention. In addition, the dot reproducibility of an electrostatic latent image can be improved, and a reduction in image density at the rear end of a solid image and a reduction in image density when the developer is used for a long time period can be suppressed.

Further feature of the present invention will become apparent from the following description of exemplary embodiments (with reference to the attached drawings).

### BRIEF DESCRIPTION OF THE DRAWINGS

FIG. 1 is a schematic view of a surface modification apparatus;

FIG. 2 is a schematic view of another surface modification apparatus;

FIG. 3 is an outline constitution view of an apparatus for measuring a specific resistance; and

FIG. 4 is an outline view of a developing device used in each of Example 19 and Comparative Example 7.

### DESCRIPTION OF REFERENCE NUMERALS

1 toner particles
2 auto-feeder
3 feeding nozzle
4 inside of surface modification apparatus
5 hot air introduction port
6 cold air introduction port
7 surface-modified toner particles
8 cyclone
9 blower
30 main body casing
31 cooling jacket
32 dispersion rotor
33 square disk
34 liner
35 classification rotor
36 guide ring
37 raw material loading port
38 raw material feeding valve
39 raw material feeding port
40 product discharge port
41 product discharge valve
42 product extraction port
43 top plate
44 fine powder discharge portion
45 fine powder discharge port
46 cold air introduction port
47 first space
48 second space
49 surface modification zone
50 classification zone
11 lower electrode
12 upper electrode
13 insulating material
14 ammeter
15 voltmeter
16 voltage stabilizer
17 magnetic carrier
18 guide ring
E resistance measurement cell
L thickness of sample
101 container of developer to be fed
102 developing device
103 cleaning unit
104 container of discharged developer
105 replenishing developer introduction port
106 discharge port

### DESCRIPTION OF THE EMBODIMENTS

A magnetic carrier to be used in the present invention is a carrier having resin-containing magnetic particles obtained by incorporating a resin by filling the pores of porous magnetic core particles with the resin. The resin-containing magnetic particles can be used as they are in a carrier. Alternatively, the particles each serve as a carrier core when a carrier is obtained by providing a coat layer for the surface of the carrier core for the purposes of, for example, imparting anti-contamination to the carrier and adjusting the charge quantity of the carrier.

In the present invention, when the packed bulk density and true density of the porous magnetic core particles are represented by ρ1 (g/cm³) and ρ2 (g/cm³), respectively, the porous magnetic core particles having ρ1 of 0.80 or more and 2.40 or less and ρ1/ρ2 of 0.20 or more and 0.42 or less are used. Further, and the specific resistance of the porous magnetic core particles having 1.0×10³ Ω·cm or more and 5.0×10⁷ Ω·cm or less are used.

As a result of investigation, the inventors of the present invention have gained the knowledge that, when porous magnetic core particles having a specific resistance of 1.0×10³ Ω·cm or more and 5.0×10⁷ Ω·cm or less are used, toner is favorably released from a carrier, and excellent developing performance is obtained. Although a detailed reason for the foregoing is unclear, the flow of charge in a carrier particle may play a more important role in improving the developing performance than the flow of charge in the surface of the carrier particle does. Accordingly, not only the specific resistance of the carrier but also the specific resistance of a core particle largely affects the developing performance.

It should be noted that, when the porous magnetic core particles have a specific resistance in excess of 5.0×10⁷ Ω·cm, counter charge to be described later accumulates in a carrier particle, and the carrier strongly attracts the toner so as not to release the toner, with the result that the developing performance reduces, and a reduction in density at the rear end of a solid image portion occurs.

On the other hand, when carrier particles having porous magnetic core particles having a specific resistance of less than 1.0×10³ Ω·cm are used, the dot reproducibility of an electrostatic latent image on an electrostatic latent image bearing member reduces in some cases. The phenomenon occurs via the following mechanism: since the porous magnetic core particles have a low specific resistance, charge transmits through the naps of the carrier formed on a developer carrying member, with the result that the charge leaks between the developer carrying member and the electrostatic latent image bearing member, and the electrostatic latent image is disturbed.

In the present invention, the shape and structure of a porous magnetic core particle are specific ones. As a result, the ease with which charge leaks between a developer carrying member and an electrostatic latent image bearing member is moderately adjusted while counter charge remaining on a carrier upon release of toner from a carrier particle is caused to escape to the developer carrying member, whereby the above problems are solved.

In the present invention, the following particles are used as porous magnetic core particles: when the packed bulk density and true density of the particles are represented by ρ1 (g/cm³) and ρ2 (g/cm³), respectively, ρ1 is 0.80 or more and 2.40 or less, and ρ1/ρ2 is 0.20 or more and 0.42 or less. Such porous magnetic core particles having a considerably small ratio of the packed bulk density to the true density may have a large number of pores in themselves. In particles each having such structure, the flow of charge is moderately restricted by the presence of the pores, and counter charge can be caused to escape to a developer carrying member while leak between the developer carrying member and an electrostatic latent image bearing member is moderately suppressed.

When ρ1/ρ2 is less than 0.20, the number of the pores in the porous magnetic core particles is so large that the strength of the carrier reduces, the carrier breaks when it is used for a long time period, and image quality reduces in some cases.

In addition, when ρ1/ρ2 is more than 0.42, the number of the pores in the porous magnetic core particles is small, so the flow of charge in the carrier cannot be restricted, charge leaks between a developer carrying member and an electrostatic latent image bearing member, and image quality reduces in some cases.

Accordingly, the use of porous magnetic core particles each having such structure can achieve compatibility between the acquisition of excellent developing performance and the suppression of the disturbance of an electrostatic latent image or toner image.

In addition, when the packed bulk density ρ1 (g/cm³) of the porous magnetic core particles is set to 0.80 or more and 2.40 or less, the magnetic force of the carrier can be easily controlled within an appropriate range, the adhesion of the carrier to an electrostatic latent image bearing member can be prevented, and dot reproducibility can be improved.

In addition, the above magnetic carrier has an intensity of magnetization in a magnetic field of 1,000/4π (kA/m) of preferably 30 Am²/kg or more and 80 Am²/kg or less.

When the intensity of magnetization of the carrier falls within the range, images each having good dot reproducibility can be obtained over a long time period. When the intensity of magnetization of the carrier is less than 30 Am²/kg, the carrier is apt to fly onto an electrostatic latent image bearing member at the time of development, and tends to adhere to the member. When the intensity of magnetization of the carrier exceeds 80 Am²/kg, a stress on a developer containing the carrier between the developer control blade of a developing device and a developer carrying member increases, and, if the developer is used for a long time period, there is a tendency that the developer deteriorates, and an image density reduces.

In addition, the above magnetic carrier has a residual magnetization of preferably 1.0 Am²/kg or more and 20.0 Am²/kg or less, or more preferably 2.0 Am²/kg or more and 5.0 Am²/kg or less, and has a coercive force of preferably 1.0 kA/m or more and 20.0 kA/m or less, or more preferably 5.0 kA/m or more and 18.0 kA/m or less.

When each of the residual magnetization and coercive force of the carrier falls within the above range, the flowability of a developer containing the carrier becomes particularly good, and good dot reproducibility is obtained.

Further, the above magnetic carrier has a specific resistance of preferably 1.0×10⁷ Ω·cm or more and 1.0×10¹⁰ Ω·cm or less.

When the specific resistance of the carrier falls within the above range, the injection of charge into the carrier by a developing bias can be suppressed, and the charge of the carrier can be moderately leaked. As a result, the adhesion of the carrier to an electrostatic latent image bearing member can be favorably suppressed, and the generation of a flaw in the electrostatic latent image bearing member or the transfer of the carrier onto paper to cause an image defect can be favorably suppressed. In addition, even at the time of the replenishment of a developing device with toner, charge can be favorably provided for the toner with which the device is newly replenished, and dot reproducibility can be maintained without being reduced.

The specific resistance of the carrier can be adjusted depending on, for example, the kind, pore diameters, and pore distribution of a magnetic substance, and the resin content of each of the porous magnetic core particles.

Next, approaches to adjusting the packed bulk density and true density of the porous magnetic core particles and the specific resistance of the particles within the above ranges will be described.

Examples of the approaches to adjusting those physical properties include an approach involving selecting an appropriate kind of an element and an approach involving controlling, for example, the crystal diameters, pore diameters, pore diameter distribution, and pore ratio of the particles. To be specific, the following approaches are exemplified.

(i) The temperature at which, and the time period for which, the porous magnetic core particles are formed by calcination are adjusted so that the extent to which, and the rate at which, the crystal of each of the particles grows are controlled, and the sizes, distributed state, and the like of the pores of the particles are adjusted.
(ii) Upon formation of the porous magnetic core particles, a pore-forming agent such as a blowing agent or an organic fine particle is added so that pores are produced in the porous magnetic core particles. At that time, the kind (such as composition or particle diameter) of the blowing agent is appropriately selected, and the amount of the agent is adjusted.

The above blowing agent is not particularly limited as long as it is a substance which generates a gas in association with its vaporization or decomposition at 60 to 180° C. Examples of the above blowing agent include: blowing azo polymerization initiators such as azobisisobutyronitrile, azobisdimethylvaleronitrile, and azobiscyclohexanecarbonitrile; hydrogen carbonates of metals such as sodium, potassium, and calcium; ammonium hydrogen carbonate; ammonium carbonate; calcium carbonate; an ammonium nitrate salt; an azide compound; 4,4′-oxybis(benzenesulfohydrazide); allylbis(sulfohydrazide); and diaminobenzene.

Examples of the above organic fine particles include: resins which may be used as a wax; thermoplastic resins such as polystyrene, an acrylic resin, and a polyester resin; and thermosetting resins such as a phenol resin, a polyester resin, a urea resin, a melamine resin, and a silicone resin. Each of them is turned into fine particles before use.

A known method can be employed as a method of turning each of them into fine particles. For example, each of them is pulverized into particles each having a desired particle diameter in a pulverization step. In the pulverization step, for example, the following method is employed: each of them is coarsely pulverized at first with a grinder such as a crusher, a hammer mill, or a feather mill, and, furthermore, the coarsely pulverized products are finely pulverized with a Kryptron system manufactured by Kawasaki Heavy Industries, a Super rotor manufactured by Nisshin Engineering Inc., a Turbo mill (RSS rotor/SNNB liner) manufactured by Turbo Kogyo Co., Ltd., or an air-jet pulverizer.

Alternatively, the following procedure may be performed: fine particles are classified after pulverization so that the grain size distribution of the particles is adjusted. An apparatus for the classification is, for example, a classifier or a screen classifier such as an Elbow Jet based on an inertial classification system (manufactured by Nittetsu Mining Co., Ltd.) or a Turboplex based on a centrifugal classification system (manufactured by Hosokawa Micron Corporation).

In addition, a material for the porous magnetic component core particles is, for example, (1) an iron powder with an oxidized surface, (2) a non-oxidated iron powder, (3) a metal particle formed of, for example, any one of lithium, calcium, magnesium, nickel, copper, zinc, cobalt, manganese, chromium, and a rare earth element, (4) an alloy particle containing a metal such as iron, lithium, calcium, magnesium, nickel, copper, zinc, cobalt, manganese, chromium, or a rare earth element, or an oxide particle containing any one of these elements, or (5) a magnetite particle or a ferrite particle.

The above ferrite particle is generally a sintered compact represented by the following formula:

(M1₂O)ᵤ(M2O)ᵥ(M3₂O₃)_{w}(M4O₂)ₓ(M5₂O₅)_{y}(Fe₂O₃)

(In the formula, M1 represents a monovalent metal atom, M2 represents a divalent metal atom, M3 represents a trivalent metal atom, M4 represents a tetravalent metal atom, M5 represents a pentavalent metal atom, and when u+v+w+x+y+z=1.0, u, v, w, x, and y each satisfy the relationship of 0≦(u, v, w, x, y)≦0.8, and z satisfies the relationship of 0.2<z<1.0).

In addition, in the above formula, M1 to M5 represent at least one metal atom selected from the group consisting of at least Li, Fe, Zn, Ni, Mn, Mg, Co, Cu, Ba, Sr, Ca, Si, V, Bi, In, Ta, Zr, B, Mo, Na, Sn, Ti, Cr, Al, Sc, Y, La, Ce, Pr, Nd, Sm, Eu, Gd, Tb, Dy, Ho, Er, Tm, Yb and Lu.

Of them, the structure represented by the following formula is preferable.

(M1₂O)_{w}(M₂O)ₓ(M3₂O₃)_{y}(Fe₂O₃)

(In the formula, M1 represents a monovalent metal atom, M2 represents a divalent metal atom, M3 represents a trivalent metal atom, w+x+y+z=1.0, w, x, and y each satisfy the relationship of 0≦(w, x, y)≦1.0, and z satisfies the relationship of 0.2<z<1.0.)

In addition, in the above formula, a metal atom selected from the group consisting of Ni, Cu, Zn, Li, Mg, Mn, Sr, Ca, and Ba can be used as each of M1 to M3.

Examples of the ferrite particle include a magnetic Li ferrite (for example, (Li₂O)ₐ(Fe₂O₃)_{b}(0.0<a<0.4, 0.6≦b<1.0, a+b=1)), Mn ferrite (for example, (MnO)ₐ(Fe₂O₃)_{b}(0.0<a<0.5, 0.5≦b<1.0, a+b=1)), Mn—Zn ferrite, Mn—Mg ferrite (for example, (MnO)ₐ(MgO)_{b}(Fe₂O₃)_{c}(0.0<a<0.5, 0.0<b<0.5, 0.5≦c<1.0, a+b+c=1)), Mn—Mg—Sr ferrite (for example, (MnO)ₐ(MgO)_{b}(SrO)_{c}(Fe₂O₃)_{d}(0.0<a<0.5, 0.0<b<0.5, 0.0<c<0.5, 0.5≦d<1.0, a+b+c+d=1)), Cu—Zn ferrite (for example, (CuO)ₐ(ZnO)_{b}(Fe₂O₃)_{c}(0.0<a<0.5, 0.0<b<0.5, 0.5≦c<1.0, a+b+c=1)), Ni—Zn ferrite, and Ba ferrite. The ferrite represents a main element, and may include other small amount of metals.

The Mn—Mg—Sr ferrite such as the Mn ferrite or the Mn—Zn ferrite each containing Mn is preferable from the viewpoint of the easy control of the growth rate of the crystal.

The specific resistance of the porous magnetic core particles is adjusted by reducing the surface of the magnetic particle of the magnetic carrier through a heat treatment for the magnetic component in an inert gas instead of controlling the kind of a magnetic material for the carrier. For example, the adjustment can be achieved by the following approach: the magnetic component is subjected to a heat treatment under an inert gas (such as nitrogen) atmosphere at 600° C. or higher and 1,000° C. or lower.

Carrier particles having such porous magnetic core particles having a large number of pores in themselves as described above have involved the following problem: in ordinary cases, the physical strength of each of the carrier particles is apt to be low, and the particles are apt to break.

In view of the foregoing, the inventors of the present invention have conducted investigation on an increase in physical strength of each of the porous magnetic core particles as carrier particles by the incorporation of a resin as a result of the filling of pores possessed by the particles with the resin. As a result, the inventors have gained the following knowledge.

When the 50% particle diameter (D50) on a volume basis of the magnetic carrier is represented by D50, the average breaking strength of the magnetic carrier having a particle diameter of (D50−5 μm) or more and (D50+5 μm) or less is represented by P1 (MPa), and the average breaking strength of the magnetic carrier having a particle diameter of 10 μm or more and less than 20 μm is represented by P2 (MPa), P1 is set to 20 or more and 100 or less, and P2/P1 is set to 0.50 or more and 1.10 or less, or preferably 0.70 or more and 1.10 or less because the mechanical strength of each magnetic carrier particle can be sufficiently secured, and, furthermore, the generation of a flaw in an electrostatic latent image bearing member when the carrier is used for a long time period can be suppressed.

The inventors of the present invention consider the reason for the foregoing to be as described below.

When magnetic carrier particles each having a low strength are present, the magnetic carrier is broken by a stress, which is applied to the carrier at the time of stirring in a developing device or applied to the carrier by a control member on a developer carrying member. The fine powder of magnetic particles each having a high hardness is produced from the broken carrier particles, so, when the fine powder migrates onto an electrostatic latent image bearing member, the fine powder is apt to rub the surface layer of the electrostatic latent image bearing member at the time of the cleaning of the electrostatic latent image bearing member to generate a flaw. As a result, a white stripe may be produced on a solid image.

Accordingly, the average breaking strength P1 of the magnetic carrier must be 20 MPa or more.

On the other hand, the strength of each of the porous magnetic core particles must be increased in order that the average breaking strength P1 of the magnetic carrier may be larger than 100 MPa. On the other hand, when the strength of each of the porous magnetic core particles is increased so that the average breaking strength P1 of the magnetic carrier is larger than 100 MPa, it becomes difficult to maintain the porous structure of each of the magnetic core particles.

Further, in the case of the carrier having a particle diameter of 10 μm or more and less than 20 μm, as compared to the carrier having a particle diameter of (D50−5 μm) or more and (D50+5 μm) or less, the resin hardly enters the pores of the porous magnetic core particles, and the carrier is largely affected in the case where the resin does not enter part of the pores, so the strength of the carrier is apt to reduce.

Under a high-temperature and high-humidity environment, toner having a small charge quantity is developed in a non-image region and fogging occurs in some cases.

Although the reason is not apparent, but the inventors consider as follows.

The charge-providing performance for toner as a carrier is different for the case where the resin is filled in the pores of the porous magnetic core particles and the case where the resin is not sufficiently filled in the pores of the porous magnetic core particles. This is supposed because a specific dielectric constant of resin (for example, about 4.0 for silicon resin, about 3.5 for acrylic resin) and a specific dielectric constant of air (about 1.0) are different. Further, in the case where variation in the resin filled state is large, the distribution of toner charge quantities becomes broad. Therefore, in the case of being left under a high-temperature and high-humidity environment, the toner having a small charge quantity causes fogging in some cases.

Particularly, the magnetic carrier having a particle diameter of 10 μm or more and less than 20 μm, compared to the magnetic carrier having a particle diameter of D50−5 μm or more and D50+5 μm or less, has a large specific surface area and is largely affected by the charge-providing performance for toner.

Accordingly, particularly in carrier particles each having a particle diameter of 10 μm or more and less than 20 μm, a resin component needs to be properly loaded into the porous magnetic core particles, and P2/P1 must be 0.50 or more and 1.10 or less. The charging degree of resin relates to strength of the carrier and P2/P1 can be considered as an index representing the charging degree of resin. Further, by setting P2/P1 to the above range, it is possible to suppress the occurrence of fogging under a high-temperature and high-humidity environment while maintaining the strength of the carrier.

However, when P2/P1 is larger than 1.10, the charging performance of the carrier having a particle diameter of 10 μm or more and less than 20 μm for toner differs from that of the carrier having a particle diameter of D50−5 μm or more and D50+5 μm or less. Carrier particles each having a particle diameter of 10 μm or more and less than 20 μm each have a large specific surface area, and each largely contribute to triboelectric charging performance for the toner, so, when P2/P1 exceeds 1.10, the triboelectric charge quantity distribution of the toner widens, and dot reproducibility reduces in some cases.

The following procedure suffices for setting P2/P1 to 0.50 or more and 1.10 or less: the diameters and distribution of the pores possessed by the porous magnetic core particles, the composition of the resin component to be incorporated, and, furthermore, a method of loading the resin are adjusted/selected so that the resin component is uniformly loaded.

It should be noted that, as described in detail later, the magnetic carrier has a 50% particle diameter (D50) on a volume basis of preferably 20 μm or more and 70 μm or less.

In order that the pores of the porous magnetic core particles may be uniformly filled with the resin component, for example, a resin component solution prepared by mixing the resin component and a solvent is preferably used. The amount of the resin component is preferably 1 mass % or more and 50 mass % or less, or more preferably 1 mass % or more and 30 mass % or less. When a resin component solution having a resin component amount in excess of 50 mass % is used, the viscosity of the solution is high, so there is a tendency that it is difficult for the resin component solution to load into the pores of the porous magnetic core particles uniformly. In addition, when the resin component amount is less than 1 mass %, the amount of the resin component is small, and the adhesive force of the resin to each of the porous magnetic core particles tends to reduce.

The resin component to be loaded into the porous magnetic core particles preferably shows high wettability with respect to the magnetic component of each of the porous magnetic core particles, and each of a thermoplastic resin and a thermosetting resin may be used. When a resin component showing high wettability is used, the surface of each of the porous magnetic core particles can be easily coated with the resin simultaneously with the filling of the pores of the porous magnetic core particles with the resin.

Examples of the thermoplastic resin can include the following: a polystyrene; a polymethyl methacrylate; a styrene-acrylic ester copolymer; a styrene-methacrylic ester copolymer; a styrene-butadiene copolymer; an ethylene-vinyl acetate copolymer; polyvinyl chloride; polyvinyl acetate; a polyvinylidene fluoride resin; a fluorocarbon resin; a perfluorocarbon resin; a solvent-soluble perfluorocarbon resin; polyvinyl pyrrolidone; a petroleum resin; a novolac resin; aromatic polyester resins such as a saturated alkylpolyester resin, polyethylene terephthalate, polybutylene terephthalate, and polyarylate; a polyamide resin; a polyacetal resin; a polycarbonate resin; a polyethersulfone resin; a polysulfone resin; a polyphenylene sulfide resin; and a polyetherketone resin.

Examples of the thermosetting resin can include the following: a phenol resin; a modified phenol resin; a maleic resin; an alkyd resin; an epoxy resin; an acrylic resin; unsaturated polyester obtained by polycondensation of maleic anhydride, terephthalic acid, and a polyhydric alcohol; a urea resin; a melamine resin; a urea-melamine resin; a xylene resin; a toluene resin; a guanamine resin; a melamine-guanamine resin; an acetoguanamine resin; a glyptal resin; a furan resin; a silicone resin; polyimide; a polyamideimide resin; a polyetherimide resin; and a polyurethane resin.

Resins obtained by modifying those resins are also permitted. Of those, a fluorine-containing resin such as a polyvinylidene fluoride resin, a fluorocarbon resin, or a perfluorocarbon resin, or a solvent-soluble perfluorocarbon resin, an acrylic-modified silicone resin, or a silicone resin is preferable because these resins each have high wettability with respect to the porous magnetic core particles.

Of those, a silicon resin is particularly preferable. A conventionally known silicone resin can be used as the silicone resin. Specific examples of the silicone resin include: a straight silicone resin composed only of an organosiloxane bond; and a silicone resin obtained by modifying, for example, a straight silicone resin with an alkyd, polyester, an epoxy, or urethane.

For example, the following can be given as a commercially available straight silicone resin. A KR271, KR255, or KR152 manufactured by Shin-Etsu Chemical Co., Ltd., or an SR2400 or SR2405 manufactured by Dow Corning Toray Co., Ltd is mentioned. A commercially available modified silicone resin is, for example, KR206 (alkyd-modified), KR5208 (acrylic-modified), ES1001N (epoxy-modified), or KR305 (urethane-modified) manufactured by Shin-Etsu Chemical Co., Ltd., or SR2115 (epoxy-modified) or SR2110 (alkyd-modified) manufactured by Dow Corning Toray Co., Ltd.

A general method of loading the resin component into each of the porous magnetic core particles involves: diluting the resin component with a solvent; and adding the solution to the porous magnetic core particles in the diluted solution. The solvent used here has only to be capable of dissolving each resin component. In the case of a resin soluble in an organic solvent, examples of the organic solvent include toluene, xylene, cellosolve butyl acetate, methyl ethyl ketone, methyl isobutyl ketone, and methanol. Further, in the case of a water-soluble resin component or an emulsion type resin component, water has only to be used. A method of adding the resin component diluted with a solvent into each of the porous magnetic core particles is, for example, a method involving: impregnating the particles with the resin component by an application method such as a dipping method, a spray method, a brush coating method, a fluidized bed method, or a kneading method; and volatilizing the solvent after the impregnation.

At the time of the filling of the pores of the porous magnetic core particles with the resin, or in another step, the following procedure is preferably adopted: the same resin is applied to the surface of each of the porous magnetic core particles so that the surface of each particle is coated with the resin. The surface of each of the porous magnetic core particles is treated with the resin simultaneously with the filling, whereby a carrier having a good specific resistance can be easily obtained even when no coat layer is separately provided.

Alternatively, the surface of each of the resin-containing magnetic particles may be further coated with a resin component different from the above resin component to be loaded into the porous magnetic core particles in consideration of, for example, an improvement in anti-contamination of the carrier, and the adjustment of the charge-providing performance and resistance of the carrier.

Thermoplastic resins and thermosetting resins may be used as a resin component with which the surface of each of the resin-containing magnetic particles is coated. The thermoplastic resins include the followings: polystyrene, polymethylmethacrylate, a styrene acrylic resin; a styrene-butadiene copolymer, an ethylene-vinyl acetate copolymer, polyvinyl chloride, polyvinyl acetate, a polyvinylidene fluoride resin, a fluorocarbon resin, a perfluorocarbon resin, polyvinyl pyrrolidone, a petroleum resin, a novolak resin, a saturated alkyl polyester resin, polyethylene terephthalate, polybutylene terephthalate, polyacrylate, a polyamide resin, a polyacetal resin, a polycarbonate resin, a polyether sulfone resin, a polysulfone resin, a poly phenylene sulfide resin, and a polyether ketone resin.

The thermosetting resins include the followings: a phenol resin, a modified phenol resin, maleic resin, an alkyd resin, an epoxy resin, unsaturated polyester obtained by polycondensation of maleic anhydride, terephthalic acid and polyvalent alcohol, an urea resin, a melamine resin, an urea-melamine resin, a xylene resin, a toluene resin, a guanamine resin, a melamine-guanamine resin, an acetguanamine resin, a glyptal resin, a furan resin, a silicone resin, polyimide, a polyamide-imide resin, a polyether-imide resin, and a polyurethane resin. Particularly, an acrylic resin is preferably used to improve the durability of the magnetic carrier.

The magnetic carrier has a 50% particle diameter (D50) on a volume basis of preferably 20 μm or more and 70 μm or less, or more preferably 30 μm or more and 60 μm or less from the viewpoints of triboelectric charge-providing performance for toner, the suppression of the adhesion of the carrier to an image region, and the prevention of a reduction in reproducibility of an electrostatic latent image on an electrostatic latent image bearing member.

When the 50% particle diameter (D50) on a volume basis of the magnetic carrier falls within the above range, the adhesion of the carrier to an electrostatic latent image bearing member can be suppressed, and good charge-providing performance for toner can be maintained even after duration because the carrier has a sufficient specific surface area.

The 50% particle diameter (D50) of the magnetic carrier can be adjusted by performing air classification or screen classification.

In addition, the dielectric loss tangent (tan δ=dielectric loss index ∈−/dielectric constant ∈′) of the magnetic carrier is preferably set as described below in order that the adhesion of the carrier to an electrostatic latent image bearing member and a reduction in dot reproducibility of an electrostatic latent image on the electrostatic latent image bearing member may be effectively prevented, and, furthermore, a reduction in density at the rear end of a solid image and a reduction in image density when an image is left to stand for a long time period under a high temperature and a high humidity may be prevented: tan δ always satisfies the relationship of preferably 0.0010≦ tan δ≦0.0450, or more preferably 0.0010≦tan δ≦0.0400 in the frequency range of 1×10² Hz or more to 1×10⁴ Hz or less.

Charge transfer occurs in the magnetic carrier at a relatively low frequency such as a frequency of 1×10² Hz. Accordingly, the electric field characteristic of the magnetic carrier may be mainly involved in fluctuations in the above characteristics such as the dot reproducibility and the image density.

When a value for tan δ falls within the above range at a frequency of 1×10² Hz, a carrier particle hardly undergoes an electrostatic induction phenomenon and can maintain good followability for a developing bias, and a reduction in image density at the rear end of a solid image can be suppressed. In addition, at the same time, the carrier maintains moderate insulating property, so the leak of charge can be suppressed in an additionally favorable manner, and good dot reproducibility can be maintained.

In addition, at a relatively high frequency such as a frequency of 1×10⁴ Hz, not charge transfer in the magnetic carrier but charge transfer at a contact portion between contacting magnetic carrier particles may be dominant.

When the value for tan δ falls within the above range at a frequency of 1×10⁴ Hz, charge exchange between contacting magnetic carrier particles can be favorably performed, and, even at the time of the replenishment of a developing device with toner, the rise-up of charging becomes good. In addition, even upon formation of an image after the developer has been left to stand for a long time period, the density of the image hardly reduces.

An available method of adjusting the dielectric loss tangent tan δ of the magnetic carrier within the above range involves adjusting the material quality and pore ratio of a magnetic substance to be used upon production of the porous magnetic core particles.

Next, a toner to be used in the present invention will be described.

The toner according to the present invention has toner particles each containing a binder resin, a colorant, and a wax.

The toner according to the present invention has a toner surface tension constant (kN/m) in a 45-vol % aqueous solution of methanol measured by a capillary suction time method of 3.0×10⁻⁶ kN/m or more and 1.0×10⁻⁴ kN/m or less, or preferably 4.0×10⁻⁶ kN/m or more and 1.0×10⁻⁴ kN/m or less.

The toner surface tension constant (kN/m) is calculated from the following equation when the capillary pressure of the toner measured by a capillary suction time method is represented by P_{α} (kN/m²), the specific surface area of the toner is represented by A (m²/g), and the true density of the toner is represented by B (g/cm³).

Toner surface tension constant=P_{α}/(A×B×10⁶)

The toner surface tension constant represents the magnitude of the surface tension at the outermost surface of the toner.

Particularly, the carrier of the present invention has ρ1 of 0.80 or more and 2.40 or less which is smaller than that of the general ferrite carrier. As a result, a pressure applied to a developer during stirring in a developing device is small, and a charge quantity of the toner is small, so that the dot reproducibility of an electrostatic latent image is reduced in some cases. Therefore, the control of an adhesive force between the toner and the carrier becomes necessary.

Thus, it is necessary to set a toner surface tension constant to 3.0×10⁻⁶ or more and 1.0×10⁻⁴ or less, increase a pressure upon stirring in a developing device, and increase a charge quantity of the toner.

As a result, a reduction in density at the rear end of a solid image can be alleviated, and the dot reproducibility of an electrostatic latent image on an electrostatic latent image bearing member can be improved.

A toner having a toner surface tension constant within the above range has toner particles the surface of each of which has controlled property and controlled roughness; in particular, the toner is such that the amount in which a wax is exposed to the surface of each toner particle is moderately controlled.

When the surface tension constant of the toner is larger than 1.0×10⁻⁴ (kN/m), the flowability of a developer containing the toner reduces excessively, and a reduction in density at the rear end of a solid image is apt to occur. In addition, when the surface tension constant of the toner is less than 3.0×10⁻⁶ (kN/m), flowability upon mixing of the toner with the carrier becomes excessively high. As a result, it becomes difficult to cause a developer carrying member to retain the developer properly, and the developer may leak from the inside of a developing device. In addition, the pressure applied to a developer upon stirring developer is small and a charge quantity of the toner becomes small, with the result that the dot reproducibility of an electrostatic latent image on an electrostatic latent image bearing member reduces in some cases.

The surface tension of the toner can be adjusted depending on the kind of the binder resin to be used, the kind and content of the wax, and, furthermore, a production method for the toner because the surface tension is largely affected by the surface composition of the toner. For example, the wax is used in an amount of preferably 0.5 part by mass or more and 15 parts by mass or less, or more preferably 2 parts by mass or more and 8 parts by mass or less with respect to 100 parts by mass of the binder resin. In addition, the wax has a melting point of preferably 45° C. or higher and 140° C. or lower.

Examples of the wax to be used in the present invention include the following. A hydrocarbon-based wax such as a low-molecular-weight polyethylene wax, a low-molecular-weight polypropylene wax, an alkylene copolymer, a microcrystalline wax, a paraffin wax, or a Fischer-Tropsch wax; an oxide of the hydrocarbon-based wax such as an oxidized polyethylene wax and block copolymers thereof; a wax mainly composed of an fatty acid ester, such as a carnauba wax, a behenic acid behenyl ester wax and a montanate wax; and a wax obtained by deoxidizing part of or whole fatty acid ester, such as a deoxidized carnauba wax.

The following may be given as further examples. A saturated linear fatty acids such as palmitic acid, stearic acid, and montanic acid; unsaturated fatty acids such as brassidic acid, eleostearic acid, and valinaric acid; saturated alcohols such as stearyl alcohol, aralkyl alcohol, behenyl alcohol, carnaubyl alcohol, ceryl alcohol, and mericyl alcohol; polyalcohols such as sorbitol; eaters obtained from reaction of fatty acid, such as palmitic acid, stearic acid, behenic acid and montanic acid, and alcohols, such as stearyl alcohol, aralykl alcohol, behenyl alcohol, carnauba alcohol, ceryl alcohol, and melissyl alcohol; fatty amides such as amide linoleate, amide oleate, and amide laurate; saturated fatty bisamides such as methylenebis stearate amide, ethylenebis caprate amide, ethylenebis laurate amide, and hexamethylenebis stearate amide; unsaturated fatty amides such as ethylenebis oleate amide, hexamethylenebis oleate amide, N,N′-dioleyl adipate amide, and N,N′-dioleyl sebacate amide; aromatic bisamides such as m-xylenebis stearate amide and N,N′-distearyl isophthalate amide; fatty metal salts (which is generally referred to as “metal soap”) such as calcium stearate, calcium laurate, zinc stearate, and magnesium stearate; a grafted wax obtained by subjecting an aliphatic hydrocarbon wax to graft reaction with a vinyl monomer such as styrene or acrylic acid; a partial esterified product obtained from reaction of a fatty acid and a polyalcohol, such as monoglyceride behenate; and a methylester compound having a hydroxyl group, which is obtained by hydrogenating a vegetable oil.

In addition, after pulverization, for example, a sphering treatment or a treatment involving applying a mechanical impact force while discharging a fine powder produced upon production of toner particles to the outside of a system is preferably performed with a Hybridization System manufactured by NARA MACHINERY CO., LTD. or a Mechanofusion System manufactured by Hosokawa Micron Corporation. The surface of each of the toner particles is modified by any such treatment so that the wax is exposed to the surface of each toner particle to some extent, whereby the surface tension of the toner can be controlled.

A developer using the above toner and the above magnetic carrier can effectively prevent a reduction in image density at the time of long-term duration. In addition, the toner contains the wax, so an image can be fixed without the application of any oil to a fixing unit, and the gloss of the fixed image can be controlled.

Next, a binder resin contained in the toner will be described.

As the binder resin, the followings are exemplified: polyester and polystyrene; polymers of styrene derivatives, such as poly-p-chlorstyrene and polyvinyltoluene; styrene copolymers such as a styrene-p-chlorstyrene copolymer, a styrene-vinyltoluene copolymer, a styrene-vinylnaphthaline copolymer, a styrene-acrylate copolymer, a styrene-methacrylate copolymer, a styrene-a-methyl chlormethacrylate copolymer, a styrene-acrylonitrile copolymer, a styrene-vinylmethyl ketone copolymer, a styrene-butadiene copolymer, a styrene-isoprene copolymer, and a styrene-acrylonitrile-indene copolymer; polyvinyl chloride, a phenol resin, a modified phenol resin, a maleic resin, an acrylic resin, a methacrylic resin, polyvinylacetate, and a silicone resin; polyester resins having as a structural unit a monomer selected from aliphatic polyalcohols, aliphatic dicarboxylic acids, aromatic dicarboxylic acids, aromatic dialcohols, and diphenols; a polyurethane resin, a polyamide resin, a polyvinyl butyral, a terpene resin, a coumarone-indene resin, and a petroleum resin.

Examples of the colorant to be incorporated into the toner are as described below.

A black colorant is, for example, carbon black, a magnetic substance, or a colorant toned to a black color by using a yellow colorant, a magenta colorant, and a cyan colorant.

A pigment may be used alone in the colorant; a dye and a pigment are more preferably used in combination so that the definition of the colorant is improved in terms of the quality of a full-color image.

As the coloring pigment for magenta toner, the followings are exemplified: C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 49, 50, 51, 52, 53, 54, 55, 57, 58, 60, 63, 64, 68, 81, 83, 87, 88, 89, 90, 112, 114, 122, 123, 163, 202, 206, 207, 209, and 238; C. I. Pigment Violet 19; and C.I. Bat Red 1, 2, 10, 13, 15, 23, 29, and 35.

As the dye for magenta toner, the followings are exemplified: C.I. Solvent Red 1, 3, 8, 23, 24, 25, 27, 30, 49, 81, 82, 83, 84, 100, 109, and 121; C.I. Disperse Red 9; C.I. Solvent Violet 8, 13, 14, 21, and 27; oil soluble dye such as C.I. Disperse Violet 1, C.I. Basic Red 1, 2, 9, 12, 13, 14, 15, 17, 18, 22, 23, 24, 27, 29, 32, 34, 35, 36, 37, 38, 39, and 40; and basic dyes such as C.I. Basic Violet 1, 3, 7, 10, 14, 15, 21, 25, 26, 27, and 28.

As the coloring pigment for cyan toner, the followings are exemplified: C.I. Pigment Blue 2, 3, 15:3, 15:4, 16, and 17; C.I. Bat Blue 6; and C.I. Acid Blue 45, and a copper phthalocyanine pigment whose phthalocyanine skeleton is substituted with 1 to 5 phthalimide methyl groups.

As the coloring pigment for yellow, the following are exemplified: C.I. Pigment Yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181, and 185; and C.I. Bat Yellow 1, 3, and 20.

As the coloring dye for yellow, C.I. Solvent Yellow 162 is mentioned.

The colorant is used in an amount of preferably 0.1 part by mass or more and 30 parts by mass or less, more preferably 0.5 part by mass or more and 15 parts by mass or less, or most preferably 3 parts by mass or more and 10 parts by mass or less with respect to 100 parts by mass of the binder resin.

When required, a charge control agent may be incorporated in the toner of the present invention. As the charge control agent contained in the toner, conventional one can be used, in particular, a metallic compound of an aromatic carboxylic acid is preferred because it has no color, has a high toner charge speed, and can retain a constant charge amount stably.

As a negative charge control agent to be used there are exemplified a metallic compound of salicylic acid, a metallic compound of naphthoic acid, a metallic compound of dicarboxylic acid, a high-molecular compound having sulfonic acid or carboxylic acid in the side chain, a high-molecular compound having a sulfonic acid salt or a sulfonic esterified product in the side chain, a high-molecular compound having a carboxylic acid salt or a carboxylic esterified product, a boron compound, a urea compound, a silicon compound, and a calixarene. As a positive charge control agent to be used there are exemplified a quaternary ammonium salt, a high-molecular compound having the quaternary ammonium salt in the side chain, a guanidine compound, and an imidazole compound. The charge control agent may be added to toner particles internally or externally. The amount of the charge control agent to be added is preferably 0.2 or more and 10 parts or less by mass with respect to 100 parts by mass of a binder resin.

An external additive is preferably added to the toner for improving the flowability of the toner. Preferable examples of the external additive include inorganic fine powders formed of, for example, silica, titanium oxide, and aluminum oxide. Each of the inorganic fine powders is preferably made hydrophobic with a hydrophobic agent such as a silane coupling agent, silicone oil, or a mixture of them.

The external additive is used in an amount of preferably 0.1 part by mass or more and 5.0 parts by mass or less with respect to 100 parts by mass of the toner particles.

The toner particles and the external additive can be mixed by using a known mixer such as a Henschel mixer.

The toner has a weight-average particle diameter (D4) of preferably 3 μm or more and 11 μm or less for achieving compatibility between high image quality and durability. When the weight-average particle diameter (D4) falls within the above range, the flowability of the toner is good and easily obtains a sufficient charge quantity, and a good resolution is easily obtained.

In addition, the toner has an average circularity of preferably 0.930 or more and less than 0.990. It should be noted that the average circularity is based on a circularity distribution as a result of analysis in which the circularities of particles measured with a flow-type particle image measuring apparatus having such a resolution that one field of view is composed of 512 pixels×512 pixels and each pixel measures 0.37 μm by 0.37 μm are allotted to channels obtained by dividing a circularity range of 0.20 to 1.00 into 800 sections.

When the average circularity of the toner falls within the above range, releasing performance between the carrier and the toner is good, and a sufficient image density is easily obtained even at the rear end of a solid image portion. In addition, good cleaning performance is easily obtained.

Next, a method of producing the toner of the present invention will be described. The toner can be produced through, for example, the following steps.

In a raw material mixing step, predetermined amounts of at least a binder resin, a colorant, and a wax, and another component such as a charging control agent as required are weighted, and then compounded and mixed together by a mixing device as agents constituting toner. Examples of the mixing device include a double con mixer, a V-type mixer, a drum-type mixer, a Super mixer, a Henschel mixer, and a nauta mixer.

Next, the mixed materials are melted and kneaded, and the colorant and the like are dispersed in the binder resin. In the melting and kneading step, for example, a batch kneader such as a pressure kneader, a Banbury mixer, etc or a continuous kneader can be used. Recently, due to the advantage of allowing continuous production, a single-screw or twin-screw extruder is becoming mainstream. For example, a KTK series twin-screw extruder from KOBE STEEL, LTD., a TEM series twin-screw extruder from TOSHIBA MACHINE CO., LTD., PCM kneader from Ikegai, Ltd., a twin-screw extruder from KCK Corporation, a co-kneader from Buss Co., Ltd., and the like can be used.

The precolored resin composition obtained by melting and kneading the toner raw materials is rolled out by two rolls or the like, and then cooled through a cooling step of cooling the composition by water cooling or the like.

Subsequently, the cooled product of the resin composition is pulverized into particles each having a desired particle diameter in a pulverization step. In the pulverization step, the cooled product is coarsely pulverized with a grinder such as a crusher, a hammer mill, or a feather mill, and, furthermore, the coarsely pulverized products are finely pulverized with, for example, a Kryptron system manufactured by Kawasaki Heavy Industries, a Super rotor manufactured by Nisshin Engineering Inc., a Turbo mill (RSS rotor/SNNB liner) manufactured by Turbo Kogyo Co., Ltd., or an air-jet pulverizer.

After that, the resultant fine particles are classified with a classifier or a screen classifier such as an Elbow Jet based on an inertial classification system (manufactured by Nittetsu Mining Co., Ltd.) or a Turboplex based on a centrifugal classification system (manufactured by Hosokawa Micron Corporation) as required, whereby toner particles are obtained.

In addition, after the pulverization, a surface modification treatment for the toner particles such as a sphering treatment can be performed with a Hybridization System manufactured by NARA MACHINERY CO., LTD. or a Mechanofusion System manufactured by Hosokawa Micron Corporation as required.

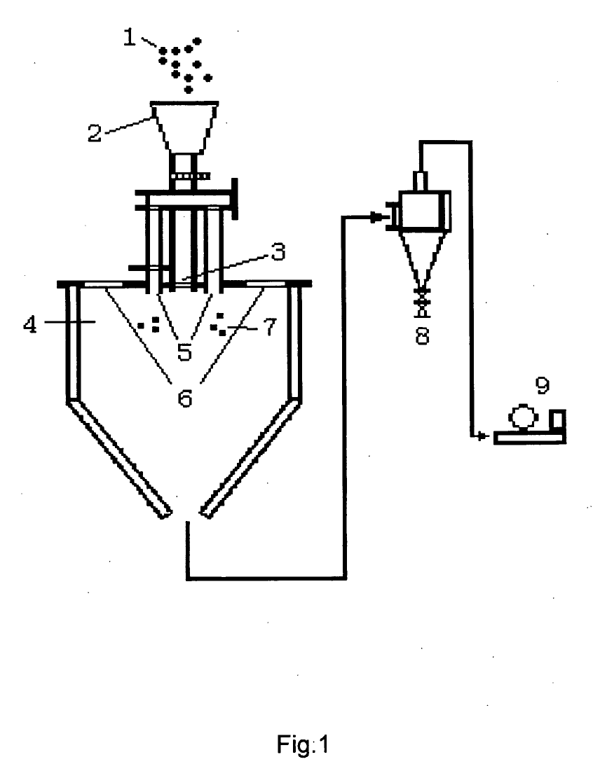

For example, such surface modification apparatus as shown in FIG. 1 can be used in the modification of the surface of a toner particle. Toner particles 1 are fed in a constant amount to an inside 4 of the surface modification apparatus through a feeding nozzle 3 using an auto-feeder 2. The toner particles 1 introduced from the feeding nozzle 3 are dispersed in the apparatus because the inside 4 of the surface modification apparatus is sucked with a blower 9. The toner particles 1 dispersed in the apparatus are momentarily heated with hot air introduced from a hot air introduction port 5 so that their surfaces are modified. In the present invention, the hot air is generated with a heater; an apparatus is not particularly limited as long as the apparatus can generate hot air sufficient for the modification of the surfaces of the toner particles. Surface-modified toner particles 7 are instantaneously cooled with cold air introduced from a cold air introduction port 6. In the present invention, liquid nitrogen is used to serve as the cold air; means is not particularly limited as long as the surface-modified toner particles 7 can be instantaneously cooled with the means. The surface-modified toner particles 7 are sucked with the blower 9 and collected with a cyclone 8.

Alternatively, an apparatus for performing a treatment involving applying a mechanical impact force while discharging a fine powder produced upon production of toner particles to the outside of the system can also be used.

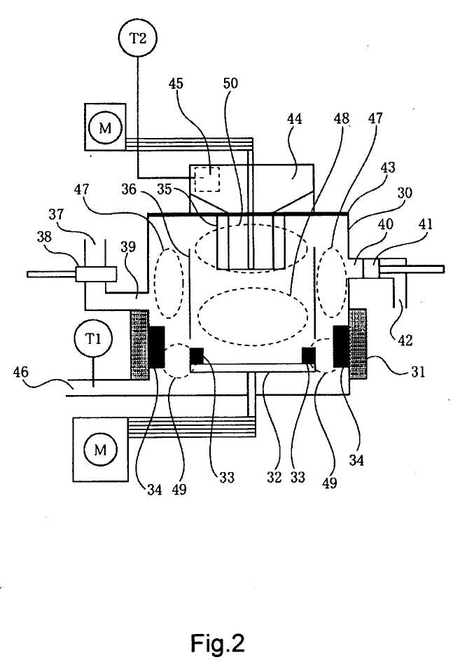

FIG. 2 is a schematic sectional view showing an example of the constitution of the apparatus of the present invention. The surface modification apparatus shown in FIG. 2 is formed of the following members: a casing 30; a jacket 31 through which cooling water or antifreeze can pass; a dispersion rotor 32 as surface modification means, the dispersion rotor 32 being present in the casing 30 and attached to a central rotation axis, the dispersion rotor 32 having multiple square disks 33 or cylindrical pins (not shown) on its upper surface, and the dispersion rotor 32 being a disk-like rotator rotating at a high speed; a liner 34 placed on the outer periphery of the dispersion rotor 32 with a certain interval between the liner and the rotor, the liner 34 being provided with a large number of grooves on its surface (it should be noted that no grooves may be present on the liner surface); a classification rotor 35 as means for classifying surface-modified raw materials depending on a predetermined particle diameter; a cold air introduction port 46 for introducing cold air; a raw material feeding port 39 for introducing raw materials to be treated; a discharge valve 41 placed so as to be openable and closable for freely adjusting a surface modification time; a powder discharge port 45 for discharging a powder after a treatment; and a cylindrical guide ring 36 as guiding means for partitioning a space between the classification rotor 35 and a set of the dispersion rotor 32 and the liner 34 into a first space 47 before the introduction of the raw materials to the classification rotor 35 and a second space 48 for introducing particles from which a fine powder has been removed by classification means by the classification rotor 35 to surface treatment means. A gap portion between the dispersion rotor 32 and the liner 34 is a surface modification zone, and the classification rotor 35 and its peripheral portion constitute a classification zone.

In the surface modification apparatus constituted as described above, when finely pulverized products are loaded from the raw material feeding port 39 in a state where the discharge valve 41 is closed, the loaded finely pulverized products are firstly sucked by a blower (not shown) and classified by the classification rotor 35. At this time, a fine powder having a particle diameter equal to or smaller than the predetermined particle diameter obtained as a result of the classification is removed by being continuously discharged to the outside of the apparatus. A coarse powder having a particle diameter equal to or larger than the predetermined particle diameter is guided to the surface modification zone by a circulation flow generated by the dispersion rotor 32 along the inner periphery of the guide ring 36 (the second space 48) by virtue of a centrifugal force.

The raw materials guided to the surface modification zone receive a mechanical impact force between the dispersion rotor 32 and the liner 34 to be subjected to a surface modification treatment. The particles with their surfaces modified ride on cold air passing through the inside of the apparatus, whereby the particles are guided to the classification zone along the outer periphery of the guide ring 36 (the first space 47). A fine powder generated at that time is discharged by the classification rotor 35 to the outside of the apparatus again, and a coarse powder rides on the circulation flow to return to the surface modification zone again. Then, the coarse powder repeatedly receives a surface modification action. After a predetermined time period has passed, the discharge valve 41 is opened, and the surface-modified particles are collected from the product discharge port 40.

In the step of the surface modification treatment with the above surface modification apparatus the circularity of the toner can be controlled by adjusting the time period commencing on the loading of the finely pulverized products from the raw material feeding port 39 and ending on the opening of the discharge valve (cycle time) and the number of revolutions of the dispersion rotor.

Lengthening the cycle time or increasing the circumferential speed of the dispersion rotor is effective in increasing the average circularity. When the cycle time is lengthened, the amount of the wax on the surface of the toner may increase. Accordingly, the following setting is effective in causing the circularity of the toner to fall within the above range: the circumferential speed of the dispersion rotor is 50 m/sec or more and 500 m/sec or less, and the cycle time is 15 to 60 seconds.

A two-component developer is applicable to a known image-forming method using a two-component developer. For example, the two-component developer can be used in an image-forming method including at least the steps of: charging an electrostatic latent image bearing member; forming an electrostatic latent image on the surface of the electrostatic latent image bearing member; developing the electrostatic latent image with a two-component developer in a developing device to form a toner image; transferring the toner image onto a transfer material through or without through an intermediate transfer body; and fixing the transferred toner image to the transfer material. In this case, a toner and a magnetic carrier are mixed at a ratio of preferably 2 parts by mass or more and 35 parts by mass or less, more preferably 4 parts by mass or more and 25 parts by mass or less, or particularly preferably 5 parts by mass or more and 20 parts by mass or less of the toner with respect to 100 parts by mass of the magnetic carrier. The occurrence of fogging or the scattering of the toner in an image-forming apparatus can be easily suppressed as long as the mixing ratio falls within the above range.

A developer containing the magnetic carrier and the toner can be used also as a replenishing developer in an image-forming method which includes at least the steps of: charging an electrostatic latent image bearing member; forming an electrostatic latent image on the surface of the electrostatic latent image bearing member; developing the electrostatic latent image with a two-component developer in a developing device to form a toner image; transferring the toner image onto a transfer material through or without through an intermediate transfer body; and fixing the transferred toner image to the transfer material, and in which the developing device is replenished with the replenishing developer in accordance with a reduction in toner concentration of the two-component developer in the developing device, and an excess magnetic carrier in the developing device is discharged from the developing device.

In addition, when the developer is used as a replenishing developer in a replenishing apparatus, the carrier with its charging performance and strength reduced at the time of its long-term use can be discharged. Therefore, a reduction in density at the time of duration and an occurrence of a flaw in the electrostatic latent image bearing member can be suppressed.

Although the reason is not apparent, the inventors consider as follows.

The ρ1 of the magnetic carrier of the present invention is smaller than that of the convention ferrite carrier, and thus a difference in specific gravity between the toner and the carrier becomes small. Therefore, the carrier rarely remains in the developing device and an excellent discharge performance can be achieved.

When the developer is used as a replenishing developer, the toner is used in an amount of preferably 2 parts by mass or more and 50 parts by mass or less with respect to 1 part by mass of the magnetic carrier.

When the mixing ratio in the replenishing developer falls within the above range, the number of times of the replenishment of the developing device with the developer can be set within a moderate range, and the production of the toner with insufficient charge and the excessive deterioration of the carrier can be favorably suppressed. In addition, the amount in which the carrier is discharged can be set within an appropriate range.

In addition, the two-component developer can obtain additionally good developing performance as long as the absolute value for the triboelectric charge quantity of the toner measured by a two-component method is 10 mC/kg or more and less than 50 mC/kg because an electrostatic adhesive force between the carrier and the toner can be suppressed.

Methods of measuring the various physical properties of the magnetic carrier and the toner described above will be described below.

<Packed Bulk Density of Porous Magnetic Core Particles>

Using porous magnetic core particles as a sample, the packed bulk density of such sample is measured with a Powder Tester PT-R (manufactured by Hosokawa Micron Corporation).

In the measurement, a metallic cup is tapped in a vertically reciprocating fashion 180 times at an amplitude of 18 mm while the cup is replenished with porous magnetic core particles by using a sieve having an aperture of 500 μm vibrated at an amplitude of 1 mm until the volume of the particles is just 10 ml. Then, a packed bulk density (g/cm³) is calculated from the amount of the porous magnetic core particles after the tapping.

<True Densities of Porous Magnetic Core Particles and Toner>

Using porous magnetic core particles as a sample, the true density of such sample is measured with a dry automatic densimeter Autopycnometer (manufactured by Yuasa Ionics Inc.). In the case of toner, the toner is used as it is as a sample.

Cell: SM cell (10 ml)
Sample amount: 2.0 g (carrier), 1.5 g (toner)

The measurement method involves measuring the true density of solid or liquid on the basis of a vapor-phase substitution method. The vapor-phase substitution method, which is based on Archimedes' principle as in the case of a liquid-phase substitution method, shows high accuracy in measurement for a substance having a fine pore because a gas (argon gas) is used as a substitution medium, so measurement of micropores are accurate.

<Specific Resistance of Porous Magnetic Core Particles and Magnetic Carrier>

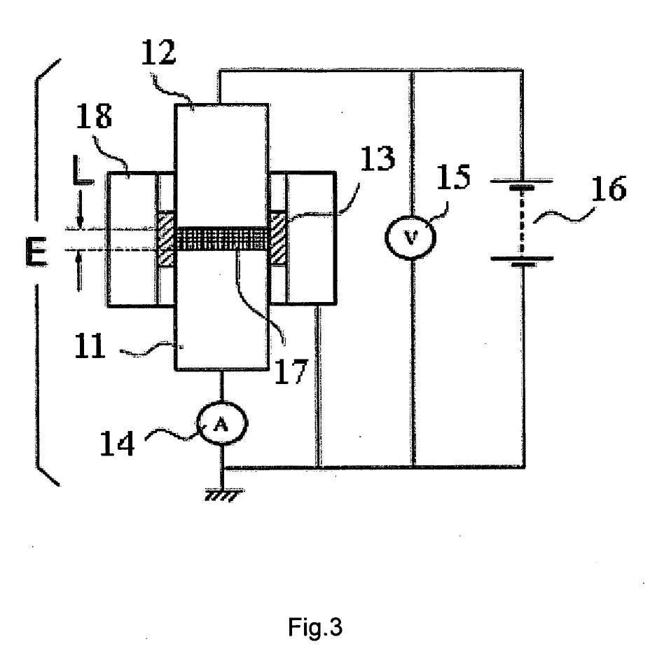

The specific resistance of the porous magnetic core particles and the magnetic carrier of the present invention are measured with a measuring apparatus shown in FIG. 3. A resistance measurement cell E is filled with a magnetic carrier 17, and a lower electrode 11 and an upper electrode 12 are placed so as to be in contact with the loaded magnetic carrier. A voltage is applied between those electrodes, and the specific resistance of the porous magnetic core particles and the magnetic carrier is determined by measuring a current flowing at that time.

The above specific resistance of porous magnetic core particles is measured under the following conditions: a contact area S between the particle and each electrode is about 2.4 cm², and the load of the upper electrode is 240 g. 10.0 g of a sample are weighed and loaded into the resistance measurement cell, and a thickness d of the sample is accurately measured. The voltage is applied under the following application conditions I, II, and III in the stated order, and a current at the applied voltage of the application condition III is measured. The specific resistance at an electric field intensity at the time of the application condition III of 100 V/cm (that is, when a value for the applied voltage divided by d equals 100 (V/cm)) is defined as the specific resistance of porous magnetic core particles.

Application condition I: (the voltage is changed from 0 V to 500 V: the voltage is increased by 100 V every 30 seconds in a stepwise manner)
II: (the voltage is held at 500 V for 30 seconds)
III: (the voltage is changed from 500 V to 0 V: the voltage is decreased by 100 V every 30 seconds in a stepwise manner)

The specific resistance of a carrier particle is measured with the same measuring apparatus as that used for the above porous magnetic core particles.

Conditions for the measurement are as described below. 1.0 g of a sample is weighed and loaded into a resistance measurement cell, and a thickness d of the sample is accurately measured.

A voltage is applied under application conditions I, II, and III in the stated order, and a current at the applied voltage under the application condition III is measured. After that, a specific resistance (Ω·cm) at each electric field intensity (V/cm) is determined by calculation. The specific resistance at an electric field intensity at the time of the application condition III of 3,000 V/cm (that is, when a value for the applied voltage divided by d equals 3,000 (V/cm)) is defined as the specific resistance of the magnetic carrier.

Application condition I: (the voltage is changed from 0 V to 1,000 V: the voltage is increased by 200 V every 30 seconds in a stepwise manner)
II: (the voltage is held at 1,000 V for 30 seconds)
III: (the voltage is changed from 1,000 V to 0 V: the voltage is decreased by 200 V every 30 seconds in a stepwise manner)

It should be noted that the specific resistance can be determined from the following equation.

Specific resistance (Ω·cm)=(applied voltage (V)/measured current (A))×S (cm²)/d (cm)

(In the equation, the value for “applied voltage (V)/d (cm)” is 100 (V/cm) in the measurement for the porous magnetic core particles, or is 3,000 (V/cm) in the measurement for the carrier.)

<Average Breaking Strength of Carrier Having Particle Diameter of (D50−5 μm) or More and (D50+5 μm) or Less and Average Breaking Strength of Carrier Having Particle Diameter of 10 μm or More and Less than 20 μm>

The average breaking strengths of the carrier are measured with a microscopic compression tester MCTM-500 (manufactured by Shimadzu Corporation). Various settings of the measuring apparatus are as described below.

| | |
|---|---|
| Measurement mode | 1 (compression test) |
| Load | 300 mN |
| Load rate | 3.87 mN/sec |
| Displacement scale | 100 μm |
| Upper pressure indenter | flat indenter having a |
| | diameter of 50 μm |
| Lower pressure plate | SKS flat plate |

The magnetic carrier on the lower pressure plate is observed with the optical monitor of the apparatus. When the 50% particle diameter (D50) on a volume basis of the magnetic carrier is represented by D50, the magnetic carrier having a particle diameter of D50−5 μm or more and D50+5 μm or less is selected at random, and the breaking strengths of 100 corresponding particles are measured. The average of the breaking strengths of the carrier is defined as the average breaking strength of carrier (P1) (MPa).

It should be noted that, in the case of a carrier having a D50 of less than 25 μm, the magnetic carrier having a particle diameter of 20 μm or more and D50+5 μm or less is subjected to the same measurement, and the resultant value is defined as P1.

In addition, the carrier having a particle diameter of 10 μm or more and less than 20 μm is also selected at random, and the breaking strengths of 30 corresponding particles are measured. The average of the breaking strengths is defined as the average breaking strength of carrier having a particle diameter of 10 μm or more and less than 20 μm (P2) (MPa).

<Method of Measuring 50% Particle Diameter On Volume Basis (D50) of Magnetic Carrier>

The 50% particle diameter on a volume basis (D50) of a magnetic carrier is measured with, for example, a multi-image analyzer (manufactured by Beckman Coulter, Inc) as described below. A solution prepared by mixing an aqueous solution of NaCl having a concentration of about 1% and glycerin at 50 vol %:50 vol % is used as an electrolyte solution. Here, the aqueous solution of NaCl has only to be prepared by using first grade sodium chloride, or, for example, an ISOTON (registered trademark)-II (manufactured by Coulter Scientific Japan, Co.) may also be used as the aqueous solution. Glycerin has only to be a reagent grade or first grade reagent.

0.5 ml of a surfactant (preferably sodium dodecylbenzenesulfonate) as a dispersant is added to the electrolyte solution (about 30 ml). Further, 10 mg of a measurement sample are added to the mixture. The electrolyte solution in which the sample has been suspended is subjected to a dispersion treatment with an ultrasonic dispersing unit for about 1 minute, whereby a dispersion liquid is obtained.

With the settings of the apparatus as described below, which uses a 200-μm aperture as an aperture and a lens having a magnification of 20, the circle-equivalent is calculated.

| Average brightness in measurement frame: | 220 to 230 |
|---|---|
| Measurement frame setting: | 300 |
| Threshold (SH): | 50 |
| Binarization level: | 180 |

The electrolyte solution and the dispersion liquid are charged into a glass measurement container, and the concentration of the magnetic carrier particles in the measurement container is set to 10 vol %. The contents in the glass measurement container are stirred at the maximum stirring speed. A suction pressure for the sample is set to 10 kPa. When the magnetic carrier particles has so large a specific gravity as to be apt to sediment, a time period for the measurement is set to 20 minutes. In addition, the measurement is suspended every 5 minutes, and the container is replenished with the sample liquid and the mixed solution of the electrolyte solution and glycerin.

There are 2,000 particles. After the completion of the measurement, blurred images, agglomerated particles (multiple particles are simultaneously subjected to measurement), and the like are removed from a particle image screen with software in the main body of the apparatus.

The circle-equivalent diameter of the magnetic carrier is calculated from the following equation.

Circle-equivalent diameter=(4·Area/π)^{1/2}

The term “Area” as used herein is defined as the projected area of a binarized particle image. A circle-equivalent diameter is represented as the diameter of a true circle when the “Area” is regarded as the area of the true circle. The resultant individual circle-equivalent diameters are classified into 256 divisions ranging from 4 to 100 μm, and are plotted on a logarithmic graph on a volume basis, whereby a 50% particle diameter on a volume basis (D50) is determined.

<Dielectric Loss Tangent of Magnetic Carrier>

The dielectric loss tangent of a magnetic carrier is measured with a 4284A Precision LCR Meter (manufactured by Hewlett-Packard Company). To be specific, the above apparatus is calibrated at frequencies of 1×10² Hz and 1×10⁴ Hz before use.

A magnetic carrier to be subjected to the measurement is left to stand under a normal-temperature, normal-humidity environment (23° C./60%) for 24 hours or longer before use. An ARES (manufactured by TA Instruments) mounted with a dielectric constant measuring jig having a diameter of 25 mm at its upper portion and with a dielectric constant measuring jig having a diameter of 40 mm at its lower portion is used as an apparatus for fixing a sample. A Teflon resin formed into a ring shape having a diameter of 35 mm and a height of 10 mm is used between the upper and lower dielectric constant measuring jigs in order that the magnetic carrier subjected to moisture conditioning may be uniformized to have a constant thickness. The ring-shaped Teflon resin is placed on the lower dielectric constant measuring jig at the center of the jig, and the magnetic carrier is loaded into the ring to fill the hollow portion. After that, the accurate thickness of a molded sample in a state where a load of 0.98 N (100 g) is applied from the upper dielectric constant measuring jig is input, and the dielectric loss tangent is measured at normal temperature (23° C.) with the LCR Meter. The dielectric loss tangent (tan δ) at a frequency of 10² Hz, 10³ Hz, or 10⁴ Hz is measured three times, and an average for each frequency is calculated, whereby the loss tangent at each frequency is obtained.

<Intensity of Magnetization, Residual Magnetization, and Coercive Force of Carrier>

The intensity of magnetization of a carrier can be determined with, for example, a vibration magnetic field-type magnetic property apparatus “vibrating sample magnetometer” (VSM) or a DC magnetizing property recorder (B—H tracer). The intensity of magnetization can be preferably measured with the vibration magnetic field-type magnetic property apparatus. Examples of the vibration magnetic field-type magnetic property apparatus include a vibration magnetic field-type magnetic property automatic recorder BHV-30 manufactured by Riken Denshi. Co., Ltd. The intensity of magnetization can be measured with the recorder in accordance with the following procedure. The carrier is loaded into a cylindrical plastic container having a sectional area of about 2.5 cm² so that the container is closely packed with the carrier to a sufficient extent. In the state, the magnetizing moment of the carrier is measured, an actual volume when the sample (carrier) is loaded is measured, and the intensity of magnetization per unit volume is determined by using the moment and the volume. The measurement is performed as follows: a magnetic field is gradually applied, is changed up to 3,000/4π (kA/m), and is then reduced. Finally, the hysteresis curve of the sample is obtained. The intensity of magnetization (Am²/kg), residual magnetization (Am²/kg), and coercive force (kA/m) of the carrier when the magnetic field is 1,000/4π (kA/m) are determined from the curve.

<Average Circularity of Toner>

The average circularity of toner is measured with a flow-type particle image analyzer “FPIA-3000 model” (manufactured by SYSMEX CORPORATION) under the same measurement and analysis conditions as those at the time of a calibration operation for the apparatus.

The measurement principle of the flow-type particle image analyzer “FPIA-3000 type” (manufactured by SYSMEX CORPORATION) is as follows: flowing particles are photographed as a static image, and the image is analyzed. A sample added to a sample chamber is transferred to a flat sheath flow cell with a sample sucking syringe. The sample transferred to the flat sheath flow cell is sandwiched between sheath liquids to form a flat flow. The sample passing through the inside of the flat sheath flow cell is irradiated with stroboscopic light at an interval of 1/60 second, whereby flowing particles can be photographed as a static image. In addition, the particles are photographed in focus because the flow of the particles is flat. A particle image is photographed with a CCD camera, and the photographed image is subjected to image processing at such an image processing resolution that one field view is composed of 512×512 pixels and each measures 0.37 μm by 0.37 μm, whereby the border of each particle image is sampled. Then, the projected area, perimeter, and the like of each particle image are measured.

Next, projected area S of each measured particle image and the perimeter L of a particle projected image are measured. With the value for area S and perimeter L, a circle-equivalent diameter and a circularity are determined. The circle-equivalent diameter is defined as the diameter of a circle having the same area as that of the projected area of a particle image, the circularity is defined as a value obtained by dividing the perimeter of a circle determined from the circle-equivalent diameter by the perimeter of a particle projected image, and the circle-equivalent diameter and the circularity are calculated from the following equations.

Circle-equivalent diameter C=2×(π×S)^{1/2}/L

When a particle image is of a complete round shape, the circularity of the particle in the image becomes 1.000. With an increase in a perimeter unevenness degree of the particle image, the circularity of the particle decreases.

After the circularities of the respective particles have been calculated, the circularities are allotted to channels obtained by dividing a circularity range of 0.200 to 1.000 into 800 sections. An average is calculated by using the central value of each channel as a representative value so that the average circularity is calculated.

A specific measurement method is as described below. 0.02 g of a surfactant, preferably a sodium dodecylbenzenesulfonate salt, as a dispersant is added to 20 ml of ion-exchanged water, and then 0.02 g of a measurement sample is added to the mixture. After the sample has been added, the mixture is subjected to a dispersion treatment with a desktop ultrasonic cleaning and dispersing machine having an oscillatory frequency of 50 kHz and an electrical output of 150 W (such as “VS-150” (manufactured by VELVO-CLEAR)) for 2 minutes, whereby a dispersion liquid for measurement is obtained. At that time, the dispersion liquid is appropriately cooled so as to have a temperature of 10° C. or higher and 40° C. or lower.

The flow-type particle image analyzer mounted with a standard objective lens (at a magnification of 10) is used in the measurement, and a particle sheath “PSE-900A” (manufactured by SYSMEX CORPORATION) is used as the sheath liquid. The dispersion liquid prepared in accordance with the procedure is introduced into the flow-type particle image analyzer, and the particle diameters of 3,000 toner particles are measured according to the total count mode of an HPF measurement mode. Then, the average circularity of the toner is determined with a binarization threshold at the time of particle analysis set to 85% and particle diameters to be analyzed limited to ones each corresponding to a circle-equivalent diameter of 2.00 μm or more and 200.00 μm or less.

Prior to the initiation of the measurement, automatic focusing is performed by using standard latex particles (obtained by diluting, for example, a 5200A manufactured by Duke Scientific with ion-exchanged water). After that, focusing is preferably performed every two hours from the initiation of the measurement.

It should be noted that, in each example, a flow-type particle image analyzer which has received a calibration certificate issued by SYSMEX CORPORATION is used, and the measurement is performed under measurement and analysis conditions identical to those at the time of the reception of the calibration certificate except that particle diameters to be analyzed are limited to ones each corresponding to a circle-equivalent diameter of 2.00 μm or more and 200.00 μm or less.

### <Method of Measuring Weight-Average Particle Diameter (D4) of Toner>

The weight-average particle diameter (D4) of toner is measured with a precision grain size distribution measuring apparatus based on a pore electrical resistance method provided with a 100-μm aperture tube “Coulter Counter Multisizer 3” (registered trademark, manufactured by Beckman Coulter, Inc) and dedicated software included with the apparatus for setting measurement conditions and analyzing measurement data “Beckman Coulter Multisizer 3 Version 3.51” (manufactured by Beckman Coulter, Inc) while the number of effective measurement channels is set to 25,000. The measurement data is analyzed so that the weight-average particle diameter is calculated.

An electrolyte solution prepared by dissolving reagent grade sodium chloride in ion-exchanged water to have a concentration of about 1 mass %, for example, an “ISOTON II” (manufactured by Beckman Coulter, Inc) can be used as an electrolyte solution to be used in the measurement.

It should be noted that the dedicated software is set as described below prior to the measurement and the analysis.

In the “change standard measurement method (SOM)” screen of the dedicated software, the total count number of a control mode is set to 50,000 particles, the number of times of measurement is set to 1, and a value obtained by using “standard particles each having a particle diameter of 10.0 μm” (manufactured by Beckman Coulter, Inc) is set as a Kd value. A threshold and a noise level are automatically set by pressing a threshold/noise level measurement button. In addition, a current is set to 1,600 μA, a gain is set to 2, and an electrolyte solution is set to an ISOTON II, and a check mark is placed in a check box as to whether the aperture tube is flushed after the measurement.

In the “setting for conversion from pulse to particle diameter” screen of the dedicated software, a bin interval is set to a logarithmic particle diameter, the number of particle diameter bins is set to 256, and a particle diameter range is set to the range of 2 μm to 60 μm.

A specific measurement method is as described below.

(1) About 200 ml of the electrolyte solution are charged into a 250-ml round-bottom beaker formed of glass dedicated for the Multisizer 3. The beaker is set in a sample stand, and the electrolyte solution in the beaker is stirred with a stirrer rod at 24 rotations/sec in a counterclockwise direction. Then, dirt and bubbles in the aperture tube are removed by the “aperture flush” function of the analysis software.
(2) About 30 ml of the electrolyte solution are charged into a 100-ml flat-bottom beaker formed of glass, and about 0.3 ml of a diluted solution prepared by diluting a “Contaminon N” (a 10-mass % aqueous solution of a neutral detergent for washing a precision measuring device composed of a nonionic surfactant, a cationic surfactant, and an organic builder and having a pH of 7, manufactured by Wako Pure Chemical Industries, Ltd.) with ion-exchanged water by three mass fold is added as a dispersant to the electrolyte solution.
(3) A predetermined amount of ion-exchanged water is charged into the water tank of an ultrasonic dispersing unit “Ultrasonic Dispersion System Tetra 150” (manufactured by Nikkaki Bios Co., Ltd.) in which two oscillators each having an oscillatory frequency of 50 kHz are built so as to be out of phase by 180° and which has an electrical output of 120 W. About 2 ml of the Contaminon N are added into the water tank.
(4) The beaker in the section (2) is set in the beaker fixing hole of the ultrasonic dispersing unit, and the ultrasonic dispersing unit is operated. Then, the height position of the beaker is adjusted in order that the liquid level of the electrolyte solution in the beaker may resonate with an ultrasonic wave from the ultrasonic dispersing unit to the fullest extent possible.
(5) About 10 mg of the toner are gradually added to and dispersed in the electrolyte solution in the beaker in the section (4) in a state where the electrolyte solution is irradiated with the ultrasonic wave. Then, the ultrasonic dispersion treatment is continued for an additional 60 seconds. It should be noted that the temperature of water in the water tank is appropriately adjusted so as to be 10° C. or higher and 40° C. or lower upon ultrasonic dispersion.
(6) The electrolyte solution in the section (5) in which the toner has been dispersed is dropped with a pipette to the round-bottom beaker in the section (1) placed in the sample stand, and the concentration of the toner to be measured is adjusted to about 5%. Then, measurement is performed until the particle diameters of 50,000 particles are measured.
(7) The measurement data is analyzed with the dedicated software included with the apparatus, and the weight-average particle diameter (D4) is calculated. It should be noted that an “average diameter” on the “analysis/volume statistics (arithmetic average)” screen of the dedicated software, when the dedicated software is set to show a graph in a vol % unit, is the weight-average particle diameter (D4).

<Specific Surface Area of Toner>

The surface of a sample is caused to adsorb a nitrogen gas by using a specific surface area measuring apparatus Tristar 3000 (manufactured by Shimadzu Corporation), and the specific surface area of toner is calculated by employing a BET multipoint method.

| | |
|---|---|
| Sample cell | Round flask type (the inner |
| | volume of a bulb portion is about 5 cm³) |
| Sample amount | 1.0 g |

<Capillary Pressure of Toner>

5.5 g of toner are gently loaded into a measurement cell, and the cell is subjected to a tapping operation with a Tapping Machine PTM-1 model manufactured by SANKYO PIO-TECH. CO., Ltd. at a tapping speed of 30 times/min for 1 minute. A sample thus obtained is set in a WTMY-232A model Wet Tester manufactured by SANKYO PIO-TECH. CO., Ltd., and the capillary pressure of the toner is measured.

The capillary pressure is determined by a constant flow rate method.

| | |
|---|---|
| Solvent | 45-vol % aqueous solution of |
| | methanol |
| Measurement mode | Constant flow rate method |
| | (A2 mode) |
| Liquid flow rate | 2.4 ml/min |
| Cell | Y-type measurement cell |

It should be noted that the surface tension constant of the toner is calculated from the below equation by using the resultant capillary pressure.

Toner surface tension constant=P_{α}/(A×B×10⁶)

(in the equation, P_{α} is capillary pressure (kN/m²), A is specific surface area (m²/g) of toner, and B is true density (g/cm³) of toner)

<Triboelectric Charge Quantity of Toner by Two-Component Method>

9.2 g of a magnetic carrier are weighed in a 50-ml polybottle (made by polyethylene). 0.8 g of toner is weighed on the magnetic carrier, and the laminate of the magnetic carrier and the toner is subjected to moisture conditioning under a normal-temperature, normal-humidity environment (23° C., 60% RH) for 24 hours After the moisture conditioning, the polybottle is capped, and is rotated with a roll mill fifteen times at a speed of one rotation per one second. Subsequently, the polybottle containing the sample is attached to a shaker (Model-YS, manufactured by Tayoi Co., Ltd.), and is shaken at a stroke of 150 times/min so that the toner and the magnetic carrier are mixed for 5 minutes, whereby a developer for measurement is prepared.

A suction separation type charge quantity measuring device Sepasoft STC-1-C1 model (manufactured by SANKYO PIO-TECH. CO., Ltd.) is used as a device for measuring a triboelectric charge quantity. A mesh (metal gauze) having an aperture of 20 μm is placed at the bottom of a sample holder (Faraday cage), 0.10 g of a developer is placed on the mesh, and the holder is capped. The mass of the entirety of the sample holder at that time is weighed and represented by W1 (g). Next, the sample holder is installed in the main body of the device, and a suction pressure is set to 2 kPa by adjusting an air quantity control valve. In this state, the toner is removed by suction for 2 minutes. Charge at that time is represented by Q (μC). In addition, the mass of the entirety of the sample holder after the suction is weighed and represented by W2 (g). Since Q thus determined corresponds to the measured value for the charge of the carrier, the triboelectric charge quantity of the toner is opposite in polarity to Q. The absolute value for the triboelectric charge quantity (mC/kg) of the developer is calculated from the following equation. It should be noted that the measurement is also performed under the normal-temperature, normal-humidity environment (23° C., 60%).

Triboelectric charge quantity (mC/kg)=Q/(W1−W2)

Hereinafter, specific examples of the present invention will be described. However, the present invention is not limited to these examples.

### <Production of Carrier>

### Porous Magnetic Core Particle Production Example 1

### 1. Weighing and Mixing Step

The following materials were weighed.

| | |
|---|---|
| Fe₂O₃ | 66.5 mass % |
| MnCO₃ | 28.1 mass % |
| Mg(OH)₂ | 4.8 mass % |
| SrCO₃ | 0.6 mass % |

Water was added to the above ferrite raw materials, and the mixture was subjected to wet mixing with a ball mill.

### 2. Temporary Calcining Step

The above mixture was dried and pulverized, and was then calcined at 900° C. for 2 hours, whereby a ferrite was produced.

### 3. Pulverizing Step

The ferrite was pulverized with a crusher into particles each having a particle diameter of about 0.1 to 1.0 mm. After that, water was added to the particles, and the resultant particles were finely pulverized with a wet ball mill into particles each having a particle diameter of 0.1 to 0.5 μm, whereby ferrite slurry was obtained.

### 4. Granulating Step

5% of polyester fine particles (having a weight-average particle diameter of 2 μm) as a pore-forming agent and 2% of polyvinyl alcohol as a binder were added to the ferrite slurry, and the mixture was granulated with a Spray Dryer (manufacturer: OHKAWARA KAKOHKI CO., LTD.) into spherical particles

### 5. Calcining Step

The spherical particles were calcined in an electric furnace under a nitrogen atmosphere having an oxygen concentration of 1.0% at 1,200° C. for 4 hours and under a nitrogen atmosphere free of oxygen at 750° C. for 30 minutes.

### 6. Sorting Step 1

The resultant calcined products were screened with a sieve having an aperture of 250 μm so that coarse particles were removed.

### 7. Sorting Step 2

The resultant particles were classified with an air classifier (Elbow Jet Lab EJ-L3, manufactured by Nittetsu Mining Co., Ltd.), whereby porous magnetic core particles 1 were obtained.

### Porous Magnetic Core Particle Production Examples 2, 3, and 10

Porous magnetic core particles 2 of a magnetic carrier were obtained in the same manner as in Porous Magnetic Core Particle Production Example 1 except that: the addition amount of the polyester fine particles in the granulating step was changed from 5% to 10%; and the addition amount of polyvinyl alcohol in the granulating step was changed from 2% to 4%.

Porous magnetic core particles 3 of a magnetic carrier were obtained in the same manner as in Porous Magnetic Core Particle Production Example 1 except that: the addition amount of the polyester fine particles in the granulating step was changed from 5% to 3%.

Porous magnetic core particles 10 of a magnetic carrier were obtained in the same manner as in Porous Magnetic Core Particle Production Example 1 except that: the addition amount of the polyester fine particles in the granulating step was changed from 5% to 20%; and the addition amount of polyvinyl alcohol in the granulating step was changed from 2% to 7%.

### Porous Magnetic Core Particle Production Example 4

Porous magnetic core particles 4 were obtained in the same manner as in Porous Magnetic Core Particle Production Example 1 except that the following calcining step 2 was performed between the calcining step and the sorting step 1: the resultant calcined products were calcined under a nitrogen atmosphere at 800° C. for 1 hour.

### Porous Magnetic Core Particle Production Example 5

Porous magnetic core particles 5 were obtained in the same manner as in Porous Magnetic Core Particle Production Example 1 except that, in the calcining step, the spherical particles were calcined in an electric furnace under a nitrogen atmosphere having an oxygen concentration of 1.5% at 1,150° C. for 4 hours.

### Porous Magnetic Core Particle Production Example 6

Porous magnetic core particles 6 were obtained in the same manner as in Porous Magnetic Core Particle Production Example 1 except that the following ferrite raw materials were used.

| | |
|---|---|
| Fe₂O₃ | 75.0 mass % |
| ZnO | 13.0 mass % |
| CuO | 12.0 mass % |

### Porous Magnetic Core Particle Production Example 7

Porous magnetic core particles 7 were obtained in the same manner as in Porous Magnetic Core Particle Production Example 1 except that the following ferrite raw materials were used.

| | |
|---|---|
| Fe₂O₃ | 78.0 mass % |
| ZnO | 12.0 mass % |
| CuO | 10.0 mass % |

### Porous Magnetic Core Particle Production Examples 8, 9, and 13

Porous magnetic core particles 8, 9, and 13 were each obtained in the same manner as in Porous Magnetic Core Particle Production Example 1 except that conditions for the spraying with the Spray Dryer in the granulating step and conditions for the classification with the air classifier (Elbow Jet Lab EJ-L3, manufactured by Nittetsu Mining Co., Ltd.) in the sorting step 2 were changed.

It should be noted that, at the time of the production of each of the porous magnetic core particles 8 and 13, the number of revolutions of the atomizer disk of the Spray Dryer was increased, and conditions were changed so that large particles were removed at the time of air classification.

In addition, at the time of the production of the porous magnetic core particles 9, the number of revolutions of the atomizer disk of the Spray Dryer was decreased, and, at the same time, conditions were changed so that small particles were removed at the time of air classification.

### Porous Magnetic Core Particle Production Example 11

Porous magnetic core particles 11 were obtained in the same manner as in Porous Magnetic Core Particle Production Example 1 except that: the addition amount of the polyester fine particles in the granulating step was changed from 5% to 1%; and, in the calcining step, the spherical particles were calcined in an electric furnace under a nitrogen atmosphere having an oxygen concentration of 0.5% at 1,100° C. for 4 hours.

### Porous Magnetic Core Particle Production Example 12

Porous magnetic core particles 12 were obtained in the same manner as in Porous Magnetic Core Particle Production Example 1 except that the following ferrite raw materials were used.

| | |
|---|---|
| Fe₂O₃ | 69.0 mass % |
| ZnO | 16.0 mass % |
| CuO | 15.0 mass % |

[Magnetic Core Particles 1]

A spherical iron powder having such physical properties as shown in Table 1 was used as magnetic core particles.

The above powder was defined as magnetic core particles 1.

[Production Example of Magnetic Core Particles 2]

Magnetic core particles 2 were obtained in the same manner as in Porous Magnetic Core Particle Production Example 1 except that: no polyester fine particles were used in the granulating step; and, in the calcining step, the spherical particles were calcined in an electric furnace under a nitrogen atmosphere having an oxygen concentration of 1.0% at 1,300° C. for 4 hours. The resultant magnetic core particles 2 were not particles each having a porous shape.

Here, Table 1 shows the physical properties of the porous magnetic core particles and of the magnetic core particles.

TABLE 1

| | 50% | | | | |
|---|---|---|---|---|---|
| | particle | | Packed | | |
| | diameter | | bulk | True | |
| | on volume | Specific | density | density | |
| | basis | resistance | ρ1 | ρ2 | |
| Core particles | D50 (μm) | (Ω · cm) | (g/cm²) | (g/cm²) | ρ1/ρ2 |
| Porous magnetic | 36 | 6.7 × 10⁶ | 1.72 | 4.94 | 0.35 |
| core particles 1 | | | | | |
| Porous magnetic | 40 | 4.2 × 10⁷ | 1.08 | 4.85 | 0.22 |
| core particles 2 | | | | | |
| Porous magnetic | 50 | 5.2 × 10⁵ | 2.01 | 4.93 | 0.41 |
| core particles 3 | | | | | |
| Porous magnetic | 42 | 2.1 × 10³ | 1.72 | 4.74 | 0.36 |
| core particles 4 | | | | | |
| Porous magnetic | 65 | 4.8 × 10⁷ | 1.61 | 4.88 | 0.33 |
| core particles 5 | | | | | |
| Porous magnetic | 43 | 5.8 × 10⁵ | 1.72 | 5.02 | 0.34 |
| core particles 6 | | | | | |
| Porous magnetic | 41 | 1.2 × 10⁶ | 2.11 | 5.18 | 0.41 |
| core particles 7 | | | | | |
| Porous magnetic | 24 | 6.8 × 10⁶ | 1.70 | 4.92 | 0.35 |
| core particles 8 | | | | | |
| Porous magnetic | 75 | 7.0 × 10⁶ | 1.79 | 4.94 | 0.36 |
| core particles 9 | | | | | |
| Porous magnetic | 42 | 7.3 × 10⁷ | 0.72 | 4.76 | 0.15 |
| core particles | | | | | |
| 10 | | | | | |
| Porous magnetic | 52 | 4.2 × 10⁴ | 2.56 | 4.98 | 0.51 |
| core particles | | | | | |
| 11 | | | | | |
| Porous magnetic | 75 | 8.2 × 10⁸ | 1.83 | 5.02 | 0.36 |
| core particles | | | | | |
| 12 | | | | | |
| Porous magnetic | 15 | 7.4 × 10⁶ | 1.75 | 4.93 | 0.35 |
| core particles | | | | | |
| 13 | | | | | |
| Magnetic core | 43 | 2.7 × 10² | 4.31 | 7.91 | 0.54 |
| particles 1 | | | | | |
| Magnetic core | 38 | 4.2 × 10⁶ | 2.72 | 4.80 | 0.57 |
| particles 2 | | | | | |

### Magnetic Carrier Production Example 1

### 1. Resin liquid preparing step

| | |
|---|---|
| Straight silicone (KR255 manufactured by | 20.0 mass % |
| Shin-Etsu Chemical Co., Ltd.) | |
| γ-aminopropyltriethoxysilane | 0.5 mass % |
| Toluene | 79.5 mass % |

The above materials were mixed, whereby a resin liquid 1 was obtained.

### 2. Resin Incorporating Step

The porous magnetic core particles 1 were filled with the resin liquid 1 so that the mass of the silicone resin accounted for 10 mass % of the mass of the porous magnetic core particles. The particles were filled with the resin liquid by using a universal mixing stirrer (product name NDMV; Fuji Paudal co., ltd) at a degree of vacuum of 50 kPa while the particles were heated to 70° C. The resin liquid 1 was charged in three portions at 0 minutes, 10 minutes, and 20 minutes. After the filling, the particles were stirred for 1 hour.

### 3. Drying Step

Toluene was removed by using a universal mixing stirrer (product name NDMV; Fuji Paudal co., ltd) at a degree of vacuum of 5 kPa while the particles were heated at 100° C. for 5 hours.

### 4. Curing Step

The resultant particles were heated with an oven under a nitrogen atmosphere at 200° C. for 3 hours so that the resin was cured.

### 5. Screening Step

The resultant particles were screened with a sieve shaker (300MM-2 model, manufactured by TSUTSUI SCIENTIFIC INSTRUMENTS CO., LTD., aperture 75 μm), whereby resin-containing magnetic particles 1 were obtained. The resin-containing magnetic particles 1 were defined as Magnetic Carrier 1. Table 2 shows the physical properties of the resultant magnetic carrier.

It should be noted that Magnetic Carrier 1 obtained here had the porous magnetic core particles the surface of each of which was coated with the resin loaded into the pores of the particles.

### Magnetic Carrier Production Example 2

In the resin incorporating step of Magnetic Carrier Production Example 1, the porous magnetic core particles 2 were used instead of the porous magnetic core particles 1, and the porous magnetic core particles were incorporated with the resin so that the mass of the resin accounted for 20 mass % of the mass of the particles.

Resin-containing magnetic particles 2 were obtained in the same manner as in Magnetic Carrier Production Example 1 except for the above changes. The resin-containing magnetic particles 2 were defined as Magnetic Carrier 2.

It should be noted that Magnetic Carrier 2 obtained here had the porous magnetic core particles the surface of each of which was coated with the resin loaded into the pores of the particles.

### Magnetic Carrier Production Example 3

In the resin incorporating step of Magnetic Carrier Production Example 1, the porous magnetic core particles 3 were used instead of the porous magnetic core particles 1, and the porous magnetic core particles were incorporated with the resin so that the mass of the resin accounted for 5 mass % of the mass of the particles.

Resin-containing magnetic particles 3 were obtained in the same manner as in Magnetic Carrier Production Example 1 except for the above changes. The resin-containing magnetic particles 3 were defined as Magnetic Carrier 3.

It should be noted that Magnetic Carrier 3 obtained here had the porous magnetic core particles the surface of each of which was coated with the resin loaded into the pores of the particles.

### Magnetic Carrier Production Examples 4 to 7, 10, 11, and 14

Resin-containing magnetic particles 4 to 7, 10, 11, and 14 were obtained in the same manner as in Magnetic Carrier Production Example 1 except that the following porous magnetic core particles were used instead of the porous magnetic core particles 1 in the resin incorporating step of Magnetic Carrier Production Example 1. The resultant resin-containing magnetic particles 4 to 7, 10, 11, and 14 were defined as Magnetic Carriers 4 to 7, 10, 11, and 14, respectively.

Magnetic Carrier 4: The porous magnetic core particles 4 were used.

Magnetic Carrier 5: The porous magnetic core particles 5 were used.

Magnetic Carrier 6: The porous magnetic core particles 6 were used.

Magnetic Carrier 7: The porous magnetic core particles 7 were used.

Magnetic Carrier 10: The porous magnetic core particles 8 were used.

Magnetic Carrier 11: The porous magnetic core particles 9 were used.

Magnetic Carrier 14: The porous magnetic core particles 12 were used.

It should be noted that each of the resultant magnetic carriers had the porous magnetic core particles the surface of each of which was coated with the resin loaded into the pores of the particles.

### Magnetic Carrier Production Example 8

### 1. Resin Liquid Preparing Step

| | |
|---|---|
| Polymethyl methacrylate (MW = 56,000) | 1.2 mass % |
| Toluene | 98.8 mass % |

The above materials were mixed, whereby a resin liquid 2 was obtained.

### 2. Resin Incorporating Step

The porous magnetic core particles 1 were filled with the resin liquid 2 so that the mass of the polymethyl methacrylate accounted for 4 mass % of the mass of the porous magnetic core particles. The particles were filled with the resin liquid by using a universal mixing stirrer (product name NDMV; Fuji Paudal co., ltd) at 60° C. The resin liquid 2 was charged in three portions at 0 minutes, 10 minutes, and 20 minutes. After the filling, the particles were stirred for 1 hour.

### 3. Drying Step

Toluene was removed by using a universal mixing stirrer (product name NDMV; Fuji Paudal co., ltd) at a degree of vacuum of 5 kPa while the particles were heated at 100° C. for 5 hours.

### 4. Curing Step

The resultant particles were heated with an oven under a nitrogen atmosphere at 220° C. for 3 hours so that the resin was cured.

### 5. Screening Step

The resultant particles were screened with a sieve shaker (300 MM-2 model, manufactured by TSUTSUI SCIENTIFIC INSTRUMENTS CO., LTD., aperture 75 μm), whereby resin-containing magnetic particles 8 were obtained. The resin-containing magnetic particles 8 were defined as Magnetic Carrier 8.

It should be noted that Magnetic Carrier 8 obtained here had the porous magnetic core particles the surface of each of which was coated with the resin loaded into the pores of the particles.

### Magnetic Carrier Production Example 9

Resin-containing magnetic particles 9 were obtained in the same manner as in Magnetic Carrier Production Example 1 except that, after the screening step of Magnetic Carrier Production Example 1, Magnetic Carrier 1 was pulverized with a collision type air pulverizer, and was then classified with an air classifier (Elbow Jet Lab EJ-L3, manufactured by Nittetsu Mining Co., Ltd.). The resin-containing magnetic particles 9 were defined as Magnetic Carrier 9.

It should be noted that Magnetic Carrier 9 obtained here had the porous magnetic core particles the surface of each of which was coated with the resin loaded into the pores of the particles.

### Magnetic Carrier Production Example 12

Resin-containing magnetic particles 12 were obtained in the same manner as in Magnetic Carrier Production Example 2 except that the porous magnetic core particles 2 were changed to the porous magnetic core particles 10. The resin-containing magnetic particles 12 were defined as Magnetic Carrier 12.

It should be noted that Magnetic Carrier 12 obtained here had the porous magnetic core particles the surface of each of which was coated with the resin loaded into the pores of the particles.

### Magnetic Carrier Production Example 13

Resin-containing magnetic particles 13 were obtained in the same manner as in Magnetic Carrier Production Example 3 except that the porous magnetic core particles 3 were changed to the porous magnetic core particles 11. The resin-containing magnetic particles 13 were defined as Magnetic Carrier 13.

It should be noted that Magnetic Carrier 13 obtained here had the porous magnetic core particles the surface of each of which was coated with the resin loaded into the pores of the particles.

### Magnetic Carrier Production Example 15

In the resin incorporating step of Magnetic Carrier Production Example 1, the amount of the resin liquid to be charged was changed so that the mass of the silicone resin accounted for 3 mass % of the mass of the porous magnetic core particles, and the total amount of the resin liquid 1 was charged at 0 minute.

Resin-containing magnetic particles 15 were obtained in the same manner as in Magnetic Carrier Production Example 1 except for the above changes. The resin-containing magnetic particles 15 were defined as Magnetic Carrier 15.

It should be noted that Magnetic Carrier 15 obtained here had the porous magnetic core particles the surface of each of which was coated with the resin loaded into the pores of the particles.

### Magnetic Carrier Production Example 16

Magnetic particles were obtained in the same manner as in Magnetic Carrier Production Example 2 except that the porous magnetic core particles 2 were changed to the porous magnetic core particles 13 in the resin incorporating step of the example. The resultant magnetic particles had the porous magnetic core particles the surface of each of which was coated with the resin loaded into the pores of the particles. 20 mass % of the resultant magnetic particles and 80 mass % of Magnetic Carrier 1 were mixed, whereby resin-containing magnetic particles 16 were obtained. The resin-containing magnetic particles 16 were defined as Magnetic Carrier 16.

### Magnetic Carrier Production Example 17

Resin-containing magnetic particles 17 were obtained in the same manner as in Magnetic Carrier Production Example 1 except that the following steps 4-2 to 4-5 were performed between the curing step and the screening step in the example. The resin-containing magnetic particles 17 were defined as Magnetic Carrier 17.

It should be noted that, in Magnetic Carrier 17 obtained here, the pores of the porous magnetic core particles were filled with the resin originating from the resin liquid 1, and the surface of each of the particles was coated with a resin originating from a resin liquid 3 together with the resin.

4-2. Resin Liquid Preparing Step 2

| | |
|---|---|
| Fluorine-acrylic resin (perfluorooctylethyl | 10 mass % |
| acrylate-methyl methacrylate copolymer; Mw = 86,000) | |
| Melamine resin fine particles (having a volume-average | 5 mass % |
| particle diameter of 350 nm) | |
| Toluene | 85 mass % |

The above materials were mixed, whereby the resin liquid 3 was obtained.

4-3. Resin Incorporating Step

The resin liquid 3 was applied to the porous magnetic core particles 1 filled with the resin after the completion of the curing step by using a universal mixing stirrer (product name NDMV; Fuji Paudal co., ltd) at 70° C. so that the solid concentration of the resin was 1 mass %. It should be noted that the total amount of the resin liquid 3 was initially charged, and the resultant particles were stirred for 2 hours.

4-4. Drying Step 2

Toluene was removed by using a universal mixing stirrer (product name NDMV; Fuji Paudal co., ltd) at a degree of vacuum of 5 kPa while the particles were heated at 90° C. for 5 hours.

4-5. Curing Step 2

The resultant particles were heated at 230° C. for 2.5 hours so that the resin was cured.

### Magnetic Carrier Production Examples 18 and 19

In the resin incorporating step of Magnetic Carrier Production Example 1, the magnetic core particles 1 or the magnetic core particles 2 were used instead of the porous magnetic core particles 1, and the magnetic core particles 1 or 2 were coated with the silicone resin so that the mass of the resin accounted for 1 mass % of the mass of the particles.

Resin-coated magnetic particles 18 and resin-coated magnetic particles 19 were obtained in the same manner as in Magnetic Carrier Production Example 1 except for the above changes. The resin-coated magnetic particles 18 were defined as Magnetic Carrier 18, and the resin-coated magnetic particles 19 were defined as Magnetic Carrier 19.

TABLE 2

| | | 50% | | | | | | | | |
|---|---|---|---|---|---|---|---|---|---|---|
| | | particle | | | | | | | | |
| | | diameter | | | | | | | | |
| | | on | Intensity | | | | | | | |
| | | volume | of | Residual | Coercive | | | tanδ | tanδ | Specific |
| | Kinds of magnetic | basis | magnetization | magnetization | force | P1 | | [Hz = | [Hz = | resistance |
| | core particles | D50 (μm) | (Am²/kg) | (Am²/kg) | (kA/m) | (MPa) | P2/P1 | 1.0 × 10²] | 1.0 × 10⁴] | (Ω · cm) |
| Magnetic | Porous magnetic core | 38 | 62 | 2.9 | 14.6 | 59 | 0.91 | 0.0231 | 0.0262 | 9.2 × 10⁸ |
| Carrier 1 | particles 1 | | | | | | | (Minimum) | (Maximum) | |
| Magnetic | Porous magnetic core | 41 | 35 | 1.3 | 6.7 | 21 | 0.87 | 0.0175 | 0.0285 | 9.7 × 10⁹ |
| Carrier 2 | particles 2 | | | | | | | (Minimum) | (Maximum) | |
| Magnetic | Porous magnetic core | 52 | 68 | 3.1 | 17.6 | 95 | 0.95 | 0.0243 | 0.0342 | 1.5 × 10⁷ |
| Carrier 3 | particles 3 | | | | | | | (Minimum) | (Maximum) | |
| Magnetic | Porous magnetic core | 43 | 55 | 2.6 | 12.4 | 48 | 0.90 | 0.0324 | 0.0328 | 6.8 × 10⁷ |
| Carrier 4 | particles 4 | | | | | | | (Minimum) | (Maximum) | |
| Magnetic | Porous magnetic core | 67 | 49 | 2.1 | 10.9 | 55 | 0.85 | 0.0023 | 0.0035 | 1.3 × 10⁸ |
| Carrier 5 | particles 5 | | | | | | | (Minimum) | (Maximum) | |
| Magnetic | Porous magnetic core | 44 | 52 | 2.8 | 14.3 | 52 | 0.78 | 0.0460 | 0.0480 | 9.8 × 10⁸ |
| Carrier 6 | particles 6 | | | | | | | (Minimum) | (Maximum) | |
| Magnetic | Porous magnetic core | 42 | 48 | 4.3 | 9.5 | 62 | 0.79 | 0.0008 | 0.0007 | 5.2 × 10⁸ |
| Carrier 7 | particles 7 | | | | | | | (Maximum) | (Minimum) | |
| Magnetic | Porous magnetic core | 37 | 54 | 2.2 | 12.4 | 32 | 0.72 | 0.0392 | 0.0381 | 2.4 × 10⁸ |
| Carrier 8 | particles 1 | | | | | | | (Maximum) | (Minimum) | |
| Magnetic | Porous magnetic core | 48 | 59 | 3.1 | 16.4 | 72 | 1.02 | 0.0028 | 0.0062 | 8.0 × 10⁹ |
| Carrier 9 | particles 1 | | | | | | | (Minimum) | (Maximum) | |
| Magnetic | Porous magnetic core | 25 | 58 | 2.8 | 13.2 | 58 | 0.93 | 0.0232 | 0.0210 | 3.4 × 10⁸ |
| Carrier 10 | particles 8 | | | | | | | (Maximum) | (Minimum) | |
| Magnetic | Porous magnetic core | 78 | 62 | 2.4 | 15.4 | 64 | 0.90 | 0.0130 | 0.0128 | 5.0 × 10⁹ |
| Carrier 11 | particles 9 | | | | | | | (Maximum) | (Minimum) | |
| Magnetic | Porous magnetic core | 43 | 29 | 1.4 | 3.2 | 18 | 0.67 | 0.0134 | 0.0128 | 2.4 × 10⁹ |
| Carrier 12 | particles 10 | | | | | | | (Maximum) | (Minimum) | |
| Magnetic | Porous magnetic core | 53 | 82 | 5.1 | 19.4 | 121 | 0.96 | 0.1245 | 0.0924 | 1.2 × 10⁸ |
| Carrier 13 | particles 11 | | | | | | | (Maximum) | (Minimum) | |
| Magnetic | Porous magnetic core | 80 | 48 | 2.8 | 14.3 | 64 | 0.82 | 0.0242 | 0.0324 | 2.5 × 10⁹ |
| Carrier 14 | particles 12 | | | | | | | (Minimum) | (Maximum) | |
| Magnetic | Porous magnetic core | 37 | 72 | 3.2 | 18.7 | 25 | 0.48 | 0.0423 | 0.0432 | 7.1 × 10⁶ |
| Carrier 15 | particles 1 | | | | | | | (Minimum) | (Maximum) | |
| Magnetic | Porous magnetic core | 32 | 60 | 2.5 | 13.5 | 75 | 1.32 | 0.0045 | 0.0058 | 3.4 × 10⁷ |
| Carrier 16 | particles 1, 13 | | | | | | | (Minimum) | (Maximum) | |
| Magnetic | Porous magnetic core | 39 | 56 | 2.6 | 15.2 | 82 | 0.92 | 0.0232 | 0.0260 | 1.2 × 10⁹ |
| Carrier 17 | particles 1 | | | | | | | (Minimum) | (Maximum) | |
| Magnetic | Magnetic core | 45 | 92 | 0.3 | 1.2 | 142 | 0.92 | 0.0124 | 0.0112 | 9.8 × 10⁶ |
| Carrier 18 | particles 1 | | | | | | | (Maximum) | (Minimum) | |
| Magnetic | Magnetic core | 39 | 82 | 7.2 | 21.4 | 105 | 0.98 | 0.0154 | 0.0424 | 4.3 × 10⁹ |
| Carrier 19 | particles 2 | | | | | | | (Minimum) | (Maximum) | |

<Production of Toner>

### Toner Production Example 1

### Production of Hybrid Resin 1

A dropping funnel was loaded with 2.0 mol of styrene, 0.21 mol of 2-ethylhexyl acrylate, 0.14 mol of fumaric acid, 0.03 mol of a dimer of α-methylstyrene, and 0.05 mol of dicumyl peroxide as materials for a vinyl polymer unit. A 4-L four-necked flask formed of glass was loaded with 7.0 mol of polyoxypropylene(2.2)-2,2-bis(4-hydroxyphenyl)propane, 3.0 mol of polyoxyethylene(2.2)-2,2-bis(4-hydroxyphenyl)propane, 3.0 mol of terephthalic acid, 1.9 mol of trimellitic anhydride, 5.0 mol of fumaric acid, and 0.2 g of tetrabutyl titanate as materials for a polyester unit. A temperature gauge, a stirring rod, a condenser, and a nitrogen introducing pipe were installed on the four-necked flask, and the four-necked flask was placed in a mantle heater. Next, air in the four-necked flask was replaced with a nitrogen gas, and then the temperature of the flask was gradually increased while the mixture in the flask was stirred. Then, the above monomers for obtaining a vinyl polymer unit and a polymerization initiator were dropped from the dropping funnel over 6 hours to the flask while the mixture in the flask was stirred at a temperature of 145° C. Next, the temperature of the resultant product was increased to 200° C., and then the product was subjected to a reaction for 6 hours, whereby Hybrid Resin 1 was obtained. Hybrid Resin 1 had a weight-average molecular weight (Mw) of 145,000, a number average molecular weight (Mn) of 4,500, and a peak molecular weight of 15,500 determined by GPC, and had Tg of 61° C. and an acid value of 45 mgKOH/g.

| | |
|---|---|
| Hybrid Resin 1 described above | 100 parts by mass |
| Refined normal paraffin (having the highest | 5 parts by mass |
| endothermic peak by DSC at 70° C.) | |
| C.I. Pigment Blue 15:3 | 5 parts by mass |

The above materials were mixed well with a Henschel mixer (FM-75 model, manufactured by Mitsui Miike Machinery Co., Ltd.), and then the mixture was kneaded with a biaxial extruder (PCM-30 model, manufactured by Ikegai, Ltd.) having a temperature set to 130° C. The resultant kneaded product was cooled, and was coarsely pulverized into products each having a size of 1 mm or less with a hammer mill, whereby coarsely pulverized products were obtained. The resultant coarsely pulverized products were finely pulverized with a collision type air pulverizer using a high-pressure gas. The resultant finely pulverized products had a weight-average particle diameter (D4) of 4.9 μm and an average circularity of 0.915.

Next, the resultant finely pulverized products were subjected to a surface treatment with the surface modification apparatus shown in FIG. 2. The finely pulverized products were loaded into the surface modification apparatus several times (1.3 kg of the products were loaded each time), and were subjected to the surface treatment for 70 seconds with the number of revolutions of the dispersion rotor 32 set to 6,300 rpm (corresponding to a circumferential speed of the outermost portion of 130 m/sec) while fine particles were removed from the products with the number of revolutions of the classification rotor 35 set to 8,200 rpm. That is, after the completion of the loading of the finely pulverized products from the raw material feeding port 39, the products were treated for 70 seconds, and were then taken out as treated products by opening the product discharge valve 41.

The setting of the surface modification apparatus was as described below. Ten square disks 33 were placed on the upper portion of the dispersion rotor 32, an interval between the guide ring 36 and each of the square disks 33 on the dispersion rotor 32 was set to 30 mm, and an interval between the dispersion rotor 32 and the liner 34 was set to 5 mm. In addition, a blower air quantity was set to 14 m³/min, and the temperature of a coolant to be passed through the jacket and a cold air temperature T1 were each set to −10° C. The apparatus was continuously operated in the state for 20 minutes, whereby a temperature T2 at the rear of the classification rotor 35 was stably 27° C.

Further, a coarse powder was removed from the above treated products with a net surface-fixed air screen Hi-bolter in which a metal gauze having a diameter of 30 cm, an aperture of 29 μm, and an average diameter of wires of 30 μm was placed (NR-300 model, manufactured by Shin Tokyo Kikai KK: the back of the metal gauze was mounted with an air brush) at an air quantity of 5 m³/min, whereby toner particles were obtained.

1.0 part by mass of a titanium oxide fine powder having a number average particle diameter of 40 nm and subjected to a hydrophobic treatment, and 0.5 part by mass of a silica fine powder having a number average particle diameter of 110 nm and subjected to a hydrophobic treatment as inorganic fine particles were externally added to and mixed with 100 parts by mass of the resultant toner particles, whereby Toner 1 was obtained.

### Toner Production Example 2

In Toner Production Example 1, Polyester Resin 1 synthesized from 2.0 mol of terephthalic acid, 0.1 mol of trimellitic anhydride, and 2.1 mol of polyoxypropylene(2.2)-2,2-bis(4-hydroxyphenyl)propane was used instead of Hybrid Resin 1.

Polyester Resin 1 had a weight-average molecular weight (Mw) of 38,000, a number average molecular weight (Mn) of 6,000, and a peak molecular weight of 8,500 determined by GPC, and had Tg of 55° C. and an acid value of 38 mgKOH/g.

In addition, 5 parts by mass of C.I. Pigment Red 122 were used instead of 5 parts by mass of C.I. Pigment Blue 15:3.

Further, a surface treatment was performed for 150 seconds while fine particles were removed with the number of revolutions of the classification rotor 35 set to 7,300 rpm, the number of revolutions of the dispersion rotor set to 5,800 rpm, and each of the temperature of the coolant to be passed through the jacket and the cold air temperature T1 set to −20° C.

Toner 2 was obtained in the same manner as in Toner Production Example 1 except for the above changes.

### Toner Production Example 3

Toner 3 was obtained in the same manner as in Toner Production Example 2 except that 4 parts by mass of C.I. Pigment Yellow 74 were used instead of 5 parts by mass of C.I. Pigment Red 122 in Toner Production Example 2.

### Toner Production Example 4

In Toner Production Example 1, Styrene Acrylic Resin 1 synthesized from 78.4 mass % of styrene, 20.8 mass % of n-butyl acrylate, 2.0 mass % of methacrylic acid, and 0.8 mass % of 2,2-bis(4,4-di-t-butylperoxycyclohexyl)propane was used instead of Hybrid Resin 1.

Styrene Acrylic Resin 1 had a weight-average molecular weight (Mw) of 35,000, a number average molecular weight (Mn) of 8,000, and a peak molecular weight of 12,000 determined by GPC, and had Tg of 63° C. and an acid value of 10 mgKOH/g.

In addition, 5 parts by mass of carbon black were used instead of 5 parts by mass of C.I. Pigment Blue 15:3, and 4 parts by mass of Fischer-Tropsch wax (having the highest endothermic peak by DSC at 77.0° C.) were used instead of 5 parts by mass of refined normal paraffin.

Toner 4 was obtained in the same manner as in Toner Production Example 1 except for the above changes.

### Toner Production Example 5

| | |
|---|---|
| Styrene | 3 parts by mass |
| n-butyl acrylate | 6 parts by mass |
| Acrylonitrile | 9 parts by mass |
| Di-t-butyl peroxide | 1 part by mass |

80 parts by mass of xylene and 10 parts by mass of a polyethylene wax were loaded into a reaction vessel, and the temperature of the mixture was increased to 170° C. A mixed liquid of the above components was dropped to the mixture over 4 hours. Further, the temperature of the resultant mixture was retained at 170° C. for 1 hour. After that, the organic solvent was removed by distillation, and the resultant polymer was subjected to cold stretch, solidified, and pulverized, whereby Graft Polymer 1 having such a structure that polyolefin was grafted to a vinyl resin was obtained.

| | |
|---|---|
| Hybrid Resin 1 described above | 100 parts by mass |
| Refined normal paraffin (having the highest | 5 parts by mass |
| endothermic peak by DSC at 70° C.) | |
| C.I. Pigment Blue 15:3 | 5 parts by mass |
| Graft Polymer 1 described above | 2 parts by mass |

The above materials were mixed well with a Henschel mixer (FM-75 model, manufactured by Mitsui Miike Machinery Co., Ltd.), and then the mixture was kneaded with a biaxial extruder (PCM-30 model, manufactured by Ikegai, Ltd.) having a temperature set to 130° C. The resultant kneaded product was cooled, and was coarsely pulverized into products each having a size of 1 mm or less with a hammer mill, whereby coarsely pulverized products were obtained. The resultant coarsely pulverized products were finely pulverized with a collision type air pulverizer using a high-pressure gas.

The resultant finely pulverized products were subjected to surface modification with the surface modification apparatus shown in FIG. 1. Conditions at the time of the surface modification were as follows: a raw material feeding rate of 2.0 kg/hr and a discharge temperature of hot air of 220° C.

Next, the surface-modified finely pulverized products were classified with an air classifier utilizing Coanda effect (Elbow Jet Lab EJ-L3, manufactured by Nittetsu Mining Co., Ltd.) so that a fine powder and a coarse powder were simultaneously classified and removed, whereby toner particles having a weight-average particle diameter (D4) of 5.1 μm were obtained.

1.5 parts by mass of a titanium oxide fine powder having a number average particle diameter of 40 nm and subjected to a hydrophobic treatment, and 0.8 part by mass of a silica fine powder having a number average particle diameter of 110 nm and subjected to a hydrophobic treatment as inorganic fine particles were externally added to and mixed with 100 parts by mass of the resultant toner particles, whereby Toner 5 was obtained.

### Toner Production Example 6

In Toner Production Example 5, 100 parts by mass of Polyester Resin 2 synthesized from 2.0 mol of terephthalic acid, 0.1 mol of trimellitic anhydride, and 2.1 mol of propylene glycol were used as a binder resin instead of 100 parts by mass of Hybrid Resin 1.

Polyester Resin 2 had a weight-average molecular weight (Mw) of 24,000, a number average molecular weight (Mn) of 5,500, and a peak molecular weight of 8,000 determined by GPC, and had Tg of 55° C. and an acid value of 64 mgKOH/g.

In addition, 10 parts by mass of refined normal paraffin (having the highest endothermic peak by DSC at 60° C.) were used instead of 5 parts by mass of the refined normal paraffin (having the highest endothermic peak by DSC at 70° C.).

Surface modification was performed with the raw material feeding rate and the discharge temperature of hot air at the time of the surface modification changed to 1.0 kg/hr and 280° C., respectively.

Toner 6 was obtained in the same manner as in Toner Production Example 5 except for the above changes.

### Toner Production Example 7

Toner 7 was obtained in the same manner as in Toner Production Example 1 except that, in Toner Production Example 1, the refined normal paraffin (having the highest endothermic peak by DSC at 70° C.) was changed to a polypropylene wax (having the highest endothermic peak by DSC at 130° C.), and the number of revolutions of the dispersion rotor 32 of the surface modification apparatus was changed from 5,800 rpm to 1,000 rpm.

### Toner Production Example 8

Toner 8 was obtained in the same manner as in Toner Production Example 1 except that the refined normal paraffin (having the highest endothermic peak by DSC at 70° C.) was changed to refined normal paraffin (having the highest endothermic peak by DSC at 43° C.) in Toner Production Example 1.

### Toner Production Example 9

In Toner Production Example 5, 5 parts by mass of the refined normal paraffin (having the highest endothermic peak by DSC at 70° C.) were changed to 20 parts by mass of refined normal paraffin (having the highest endothermic peak by DSC at 45° C.), and Graft Polymer 1 was not used.

In addition, surface modification was performed with the raw material feeding rate and the discharge temperature of hot air at the time of the surface modification set to 1.0 kg/hr and 330° C., respectively.

Toner 9 was obtained in the same manner as in Toner Production Example 5 except for the above changes.

### Toner Production Example 10

Toner 10 was obtained in the same manner as in Toner Production Example 1 except that the refined normal paraffin (having the highest endothermic peak by DSC at 70° C.) was not used in Toner Production Example 1.

### Toner Production Example 11

Toner 11 was obtained in the same manner as in Toner Production Example 1 except that 1 part by mass of refined normal paraffin (having the highest endothermic peak by DSC at 60° C.) was used instead of 5 parts by mass of the refined normal paraffin (having the highest endothermic peak by DSC at 70° C.) in Toner Production Example 1.

Table 3 shows the physical properties of the toners obtained in the foregoing.

TABLE 3

| | | Results of measurement | | | |
|---|---|---|---|---|---|
| | | by capillary suction | | | |
| | | time method | | | |
| | | | | Toner | |
| | Weight-average | Specific | Capillary | surface | |
| | particle | surface | pressure | tension | |
| | diameter D4 | area | P_{α} | constant | Average |
| Kind | (μm) | (m²/g) | (kN/m²) | (kN/m) | circularity |
| Toner 1 | 5.8 | 1.5 | 13.2 | 7.3 × 10⁻⁶ | 0.958 |
| Toner 2 | 6.3 | 1.8 | 12.4 | 5.7 × 10⁻⁶ | 0.941 |
| Toner 3 | 6.2 | 1.7 | 8.3 | 4.1 × 10⁻⁶ | 0.943 |
| Toner 4 | 6.0 | 1.4 | 11.4 | 6.8 × 10⁻⁶ | 0.941 |
| Toner 5 | 5.1 | 0.8 | 22.4 | 2.3 × 10⁻⁵ | 0.971 |
| Toner 6 | 7.5 | 0.4 | 42.1 | 8.8 × 10⁻⁵ | 0.985 |
| Toner 7 | 6.3 | 1.3 | 15.2 | 9.7 × 10⁻⁶ | 0.928 |
| Toner 8 | 6.1 | 1.4 | 13.2 | 7.9 × 10⁻⁶ | 0.932 |
| Toner 9 | 8.2 | 0.4 | 52.4 | 1.1 × 10⁻⁴ | 0.975 |
| Toner 10 | 6.0 | 1.2 | 4.2 | 2.9 × 10⁻⁶ | 0.934 |
| Toner 11 | 5.8 | 1.1 | 5.1 | 3.9 × 10⁻⁶ | 0.938 |

### Examples 1 to 20 and Comparative Examples 1 to 10

Next, two-component developers and replenishing developers were produced by combining the magnetic carriers and the toners thus produced as shown in Table 4.

Each two-component developer contained a magnetic carrier and a toner at a compounding ratio of 90 mass % 10 mass %.

A replenishing developer used in each of Example 19 and Comparative Example 7 contained a magnetic carrier and a toner at a compounding ratio of 5 mass %:95 mass %, and a replenishing developer according to any one of the other examples and comparative examples contained only a toner (toner content of 100 mass %).

TABLE 4

| | | | | Replenishing | |
|---|---|---|---|---|---|
| | Two-component developer | | | developer | |
| | Magnetic | | Q/M *1 | Magnetic | |
| | carrier | Toner | (mC/kg) | carrier | Toner |
| Example 1 | Magnetic | Toner 1 | 41 | — | Toner 1 |
| | carrier 1 | | | | |
| Example 2 | Magnetic | Toner 2 | 45 | — | Toner 2 |
| | carrier 1 | | | | |
| Example 3 | Magnetic | Toner 3 | 38 | — | Toner 3 |
| | carrier 1 | | | | |
| Example 4 | Magnetic | Toner 4 | 42 | — | Toner 4 |
| | carrier 1 | | | | |
| Example 5 | Magnetic | Toner 1 | 37 | — | Toner 1 |
| | carrier 2 | | | | |
| Example 6 | Magnetic | Toner 1 | 39 | — | Toner 1 |
| | carrier 3 | | | | |
| Example 7 | Magnetic | Toner 1 | 44 | — | Toner 1 |
| | carrier 4 | | | | |
| Example 8 | Magnetic | Toner 1 | 42 | — | Toner 1 |
| | carrier 5 | | | | |
| Example 9 | Magnetic | Toner 1 | 35 | — | Toner 1 |
| | carrier 6 | | | | |
| Example 10 | Magnetic | Toner 1 | 38 | — | Toner 1 |
| | carrier 7 | | | | |
| Example 11 | Magnetic | Toner 1 | 40 | — | Toner 1 |
| | carrier 8 | | | | |
| Example 12 | Magnetic | Toner 1 | 42 | — | Toner 1 |
| | carrier 9 | | | | |
| Example 13 | Magnetic | Toner 1 | 37 | — | Toner 1 |
| | carrier 10 | | | | |
| Example 14 | Magnetic | Toner 1 | 35 | — | Toner 1 |
| | carrier 11 | | | | |
| Example 15 | Magnetic | Toner 5 | 24 | — | Toner 5 |
| | carrier 1 | | | | |
| Example 16 | Magnetic | Toner 6 | 18 | — | Toner 6 |
| | carrier 1 | | | | |
| Example 17 | Magnetic | Toner 7 | 29 | — | Toner 7 |
| | carrier 1 | | | | |
| Example 18 | Magnetic | Toner 8 | 33 | — | Toner 8 |
| | carrier 1 | | | | |
| Example 19 | Magnetic | Toner 1 | 38 | Magnetic | Toner 1 |
| | carrier 17 | | | carrier 1 | |
| Example 20 | Magnetic | Toner | 48 | — | Toner |
| | carrier 1 | 11 | | | 11 |
| Comparative | Magnetic | Toner 1 | 35 | — | Toner 1 |
| Example 1 | carrier 12 | | | | |
| Comparative | Magnetic | Toner 1 | 38 | — | Toner 1 |
| Example 2 | carrier 13 | | | | |
| Comparative | Magnetic | Toner 1 | 37 | — | Toner 1 |
| Example 3 | carrier 14 | | | | |
| Comparative | Magnetic | Toner 9 | 41 | — | Toner 9 |
| Example 4 | carrier 1 | | | | |
| Comparative | Magnetic | Toner | 43 | — | Toner |
| Example 5 | carrier 1 | 10 | | | 10 |
| Comparative | Magnetic | Toner 1 | 38 | — | Toner 1 |
| Example 6 | carrier 15 | | | | |
| Comparative | Magnetic | Toner 1 | 37 | Magnetic | Toner 1 |
| Example 7 | carrier 15 | | | carrier | |
| | | | | 15 | |
| Comparative | Magnetic | Toner 1 | 38 | — | Toner 1 |
| Example 8 | carrier 16 | | | | |
| Comparative | Magnetic | Toner 1 | 42 | — | Toner 1 |
| Example 9 | carrier 18 | | | | |
| Comparative | Magnetic | Toner 1 | 39 | — | Toner 1 |
| Example | carrier 19 | | | | |
| 10 | | | | | |

*1 The absolute value for the triboelectric charge quantity of a toner measured by a two-component method using the toner and a magnetic carrier

Next, a color copying machine CLC-5100 (manufactured by Canon Inc.) was reconstructed by: replacing the surface layer of the fixing roller of the fixing unit of the machine with a PFA tube; and removing an oil application mechanism. Images were output by using the reconstructed device, and were subjected to an evaluation test. A developing device of the machine was charged with 400 g of a two-component developer, and was replenished with a replenishing developer in association with printing as required.

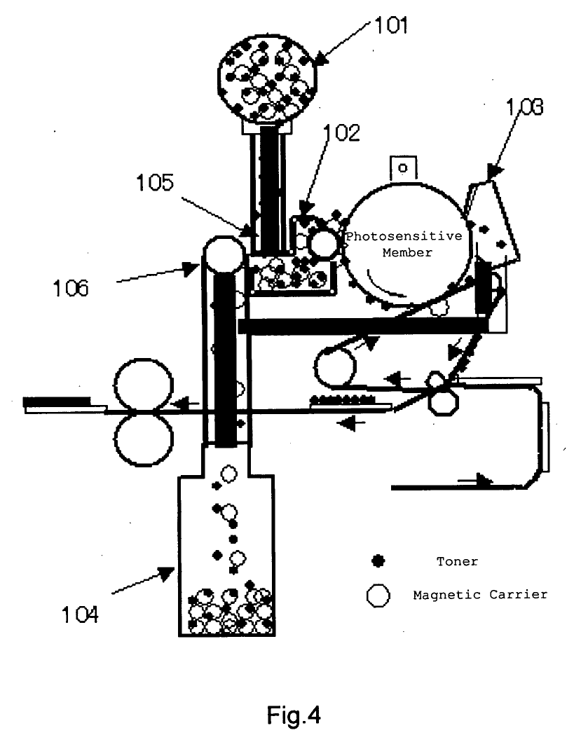

In addition, in each of Example 19 and Comparative Example 7, the developing device of the CLC-5100 was reconstructed so that a replenishing developer could be introduced from a replenishing developer introduction port 105 and an excess magnetic carrier was discharged from a discharge port 106 placed in the developing chamber of the developing device (see FIG. 4).

A duration test was performed under the following conditions. Each image was evaluated for various items to be described later before and after the duration test. Tables 5 to 8 show the results of the evaluation.

Printing environments

Temperature of 23° C./humidity of 60% RH (hereinafter
referred to as “N/N”)
Temperature of 23° C./humidity of 5% RH (hereinafter
referred to as “N/L”)
Temperature of 30° C./humidity of 80% RH (hereinafter
referred to as “H/H”)

| | |
|---|---|
| Paper | Color Laser Copier Paper (81.4 g/m²) |
| | (available from Canon Marketing Japan Inc.) |
| Image-forming rate | 400 mm/sec |
| Original image | Solid image having an image |
| | area of 50% |
| Number of printed sheets | 100,000 sheets |

<Dot Reproducibility>

A one-dot image was formed while the spot diameter of a laser beam from the CLC-5100 (manufactured by Canon Inc.) was adjusted so that the area of one dot on an image bearing member became 20,000 μm² or more and less than 25,000 μm².

The areas of 1,000 dots were measured with a digital microscope VHX-500 (mounted with a lens wide-range zoom lens VH-Z100, manufactured by KEYENCE CORPORATION).

The number average (S) and standard deviation (σ) of the dot areas were calculated, and a dot reproducibility index was calculated from the following equation.

Dot reproducibility index (I)=(σ/S)×100

A: I is less than 4.0.
B: I is 4.0 or more and less than 6.0.
C: I is 6.0 or more and less than 8.0.
D: I is 8.0 or more.

<Carrier Adhesion>

A solid image (1 cm×1 cm) was printed while a development voltage was adjusted so that a toner laid-on level on paper was 0.1 mg/cm².

The power supply of the main body of the copying machine was turned off when the solid image on an image bearing member was developed with toner, and the number of magnetic carriers adhering onto the image bearing member was counted with an optical microscope.

A: 3 or less
B: 4 or more and 10 or less
C: 11 or more and 20 or less
D: 21 or more

<Generation of Flaw in Image Bearing Member>

A solid image (3 cm×3 cm) was printed while a development voltage was adjusted so that a toner laid-on level on paper was 0.6 mg/cm².

Whether or not a stripe was generated on the image was observed with the eyes and a loupe.

A: No stripes are present.
B: 3 or less stripes each having a length of 0.3 mm or less are present on the image.
C: 4 or more and 10 or less stripes each having a length of 0.3 mm or more are present on the image.
D: 11 or more stripes each having a length of 0.3 mm or more are present on the image.

<Density Difference Between Front End and Rear End>

A solid image (3 cm×5 cm) having an image area of 100% was printed while a development voltage was adjusted so that a toner laid-on level on paper was 0.6 mg/cm². The “front end image density” and “rear end image density” of the resultant image were determined, and the image was evaluated on the basis of the following criteria concerning a difference between the densities.

It should be noted that the image densities were each measured with a Macbeth Densitometer RD918 manufactured by Macbeth Co. mounted with an SPI filter. Front end image density: Densities at three points each of which was 0.5 cm distant from the front end of the image (portion printed early) were measured, and the average of the measured values was defined as the front end image density.

Rear end image density: Densities at three points each of which was 0.5 cm distant from the rear end of the image (portion printed after) were measured, and the average of the measured values was defined as the rear end image density.
A: Less than 0.05
B: 0.05 or more and less than 0.10
C: 0.10 or more and less than 0.20
D: 0.20 or more

<Difference Between Density Before Duration and Density after Duration>

A development voltage was adjusted so that a toner laid-on level on paper was 0.6 mg/cm² before the duration test. A solid image (3 cm×3 cm) having an image area of 100% was printed under the condition. After the duration test, a solid image having an image area of 100% was printed at the same development voltage as that before the duration test.

The image densities were each measured with a Macbeth Densitometer RD918 manufactured by Macbeth Co. mounted with an SPI filter, and difference between before and after duration was measured.

A: Less than 0.05
B: 0.05 or more and less than 0.10
C: 0.10 or more and less than 0.20
D: 0.20 or more

<Difference Between Density Before Leaving and Density after Leaving>

After a 100,000-sheet duration test under each environment, a measurement environment “H/H (30° C./80% RH)” was established.

A development voltage was adjusted so that a toner laid-on level on paper was 0.6 mg/cm². A solid image (3 cm×3 cm) having an image area of 100% was printed under the condition. 24 hours after the printing, the same image was printed, and a difference between an image density before leaving for 24 hours and an image density after leaving for 24 hours was determined.

A: 0.00 or more and less than 0.05
B: 0.05 or more and less than 0.10
C: 0.10 or more and less than 0.20
D: 0.20 or more

<Fogging Evaluation>

Fogging was measured by using REFLECTMETER MODEL TC-6DS manufactured by TokyoDenshoku Co., Ltd. An amber filter was used as a filter. The fogging was calculated by using the below equation and evaluated with the below reference.

Fogging (%)=reflectance (%) on standard paper−reflectance (%) of a non-image part of the sample.

A: less than 0.5%
B: 0.5% or more and less than 1.0%
C: 1.0% or more and less than 2.0%
D: 2.0% or more

TABLE 5

| | Initial evaluation (Environment N/N) | | | | | |
|---|---|---|---|---|---|---|
| | | | | | | Difference |
| | | | | | | between |
| | | | | | Density | density |
| | | | Generation | | difference | before |
| | | | of flaw | | between | leaving and |
| | | | in image | | front end | density |
| | Dot | Carrier | bearing | Fogging | and rear | after |
| | reproducibility | adhesion | member | evaluation | end | leaving |
| Example 1 | A | A | A | A | A | A |
| Example 2 | A | A | A | A | A | A |
| Example 3 | A | A | A | A | A | A |
| Example 4 | A | A | A | A | A | A |
| Example 5 | A | A | A | A | A | A |
| Example 6 | A | B | A | A | A | A |
| Example 7 | A | B | A | A | A | A |
| Example 8 | A | A | A | A | B | A |
| Example 9 | C | A | A | A | A | A |
| Example 10 | A | A | A | A | A | A |
| Example 11 | A | A | A | A | A | A |
| Example 12 | B | A | A | A | A | A |
| Example 13 | A | A | A | A | A | A |
| Example 14 | B | A | A | A | A | A |
| Example 15 | A | A | A | A | A | A |
| Example 16 | A | A | A | A | A | A |
| Example 17 | A | A | A | A | A | A |
| Example 18 | C | A | A | A | A | A |
| Example 19 | A | A | A | A | A | A |
| Example 20 | A | A | A | A | A | A |
| Comparative | A | C | A | B | C | A |
| Example 1 | | | | | | |
| Comparative | A | A | A | A | A | A |
| Example 2 | | | | | | |
| Comparative | B | A | A | A | C | A |
| Example 3 | | | | | | |
| Comparative | C | A | A | A | D | A |
| Example 4 | | | | | | |
| Comparative | Paper wound around a fixing roller. | | | | | |
| Example 5 | | | | | | |
| Comparative | B | C | B | B | A | A |
| Example 6 | | | | | | |
| Comparative | B | C | B | B | A | A |
| Example 7 | | | | | | |
| Comparative | C | B | A | A | A | A |
| Example 8 | | | | | | |
| Comparative | No image could be printed. | | | | | |
| Example 9 | | | | | | |
| Comparative | D | A | A | A | A | A |
| Example 10 | | | | | | |

TABLE 6

| | After duration test (N/N) | | | | | | |
|---|---|---|---|---|---|---|---|
| | | | | | | Difference | Difference |
| | | | | | | between | between |
| | | | | | | density | density |
| | | | Generation | | Density | before | before |
| | | | of | | difference | duration | leaving |
| | | | flaw in | | between | and | and |
| | | | image | | front end | density | density |
| | Dot | Carrier | bearing | Fogging | and rear | after | after |
| | reproducibility | adhesion | member | evaluation | end | duration | leaving |
| Example 1 | A | A | B | A | A | A | A |
| Example 2 | A | A | B | A | A | A | A |
| Example 3 | B | A | B | A | A | A | A |
| Example 4 | A | A | B | A | A | A | A |
| Example 5 | C | A | C | A | B | A | A |
| Example 6 | A | B | B | A | A | A | A |
| Example 7 | A | B | B | A | A | A | A |
| Example 8 | B | A | B | A | C | A | A |
| Example 9 | C | A | B | A | A | A | B |
| Example 10 | A | A | B | A | B | A | C |
| Example 11 | A | A | B | B | A | A | B |
| Example 12 | C | A | B | A | C | A | B |
| Example 13 | A | A | B | A | A | A | A |
| Example 14 | C | A | B | A | A | A | A |
| Example 15 | A | A | B | A | A | A | A |
| Example 16 | A | A | B | A | A | A | A |
| Example 17 | A | A | B | A | B | A | A |
| Example 18 | C | A | B | A | C | B | A |
| Example 19 | A | A | A | A | A | A | A |
| Example 20 | C | A | B | A | A | A | A |
| Comparative | A | D | D | B | D | A | A |
| Example 1 | | | | | | | |
| Comparative | D | A | B | A | A | D | D |
| Example 2 | | | | | | | |
| Comparative | D | A | C | A | D | A | A |
| Example 3 | | | | | | | |
| Comparative | C | A | B | A | D | A | A |
| Example 4 | | | | | | | |
| Comparative | Paper wound around a fixing roller. In addition, a | | | | | | |
| Example 5 | developer leaked from a developing device. | | | | | | |
| Comparative | B | C | D | C | A | C | B |
| Example 6 | | | | | | | |
| Comparative | B | C | D | C | A | B | B |
| Example 7 | | | | | | | |
| Comparative | D | B | B | A | B | A | B |
| Example 8 | | | | | | | |
| Comparative | No image could be printed. | | | | | | |
| Example 9 | | | | | | | |
| Comparative | D | A | A | A | A | B | B |
| Example 10 | | | | | | | |

TABLE 7

| | After duration test (N/L) | | | | | | |
|---|---|---|---|---|---|---|---|
| | | | | | | Difference | Difference |
| | | | | | | between | between |
| | | | | | | density | density |
| | | | Generation | | Density | before | before |
| | | | of | | difference | duration | leaving |
| | | | flaw in | | between | and | and |
| | | | image | | front end | density | density |
| | Dot | Carrier | bearing | Fogging | and rear | after | after |
| | reproducibility | adhesion | member | evaluation | end | duration | leaving |
| Example 1 | A | A | B | A | A | B | A |
| Example 2 | A | A | B | A | A | B | A |
| Example 3 | A | A | B | A | A | B | A |
| Example 4 | A | A | B | A | A | B | A |
| Example 5 | A | A | C | A | B | C | A |
| Example 6 | A | B | B | A | A | B | A |
| Example 7 | A | B | B | A | A | B | A |
| Example 8 | A | A | B | A | C | B | A |
| Example 9 | C | A | B | A | A | B | A |
| Example 10 | A | A | B | A | A | B | B |
| Example 11 | A | A | B | A | A | B | B |
| Example 12 | B | A | B | A | C | C | A |
| Example 13 | A | A | B | A | A | B | A |
| Example 14 | B | A | B | A | A | C | A |
| Example 15 | A | A | B | A | A | B | A |
| Example 16 | A | A | B | A | A | B | A |
| Example 17 | A | A | B | A | C | B | A |
| Example 18 | C | A | B | A | C | B | A |
| Example 19 | A | A | A | A | A | A | A |
| Example 20 | B | A | B | A | A | B | A |
| Comparative | A | D | D | B | D | B | A |
| Example 1 | | | | | | | |
| Comparative | D | A | B | A | A | D | C |
| Example 2 | | | | | | | |
| Comparative | C | A | C | A | D | B | A |
| Example 3 | | | | | | | |
| Comparative | C | A | B | A | D | B | A |
| Example 4 | | | | | | | |
| Comparative | Paper wound around a fixing roller. In addition, a | | | | | | |
| Example 5 | developer leaked from a developing device. | | | | | | |
| Comparative | B | C | D | B | A | C | A |
| Example 6 | | | | | | | |
| Comparative | B | C | D | B | A | B | A |
| Example 7 | | | | | | | |
| Comparative | C | B | B | A | B | B | A |
| Example 8 | | | | | | | |
| Comparative | No image could be printed. | | | | | | |
| Example 9 | | | | | | | |
| Comparative | D | A | A | A | A | C | C |
| Example 10 | | | | | | | |

TABLE 8

| | After duration test (H/H) | | | | | | |
|---|---|---|---|---|---|---|---|
| | | | | | | Difference | Difference |
| | | | | | | between | between |
| | | | | | | density | density |
| | | | | | Density | before | before |
| | | | Generation | | difference | duration | leaving |
| | | | of flaw | | between | and | and |
| | | | in image | | front end | density | density |
| | Dot | Carrier | bearing | Fogging | and rear | after | after |
| | reproducibility | adhesion | member | Evaluation | end | duration | leaving |
| Example 1 | A | A | B | A | A | A | A |
| Example 2 | A | A | B | A | A | A | A |
| Example 3 | B | A | B | A | A | A | A |
| Example 4 | B | A | B | A | A | A | A |
| Example 5 | C | A | C | A | B | A | A |
| Example 6 | B | B | B | A | A | A | A |
| Example 7 | B | B | B | A | A | A | A |
| Example 8 | B | A | B | A | C | A | A |
| Example 9 | C | A | B | B | A | A | B |
| Example 10 | A | A | B | B | C | A | C |
| Example 11 | B | A | B | B | A | A | C |
| Example 12 | C | A | B | A | C | A | B |
| Example 13 | B | A | B | A | A | A | A |
| Example 14 | C | A | B | A | A | A | A |
| Example 15 | A | A | B | A | A | A | A |
| Example 16 | A | A | B | A | A | A | A |
| Example 17 | A | A | B | A | C | A | A |
| Example 18 | C | A | B | A | C | B | A |
| Example 19 | A | A | A | A | A | A | A |
| Example 20 | C | A | B | A | A | A | A |
| Comparative | A | C | D | C | D | B | A |
| Example 1 | | | | | | | |
| Comparative | D | A | B | A | A | C | D |
| Example 2 | | | | | | | |
| Comparative | D | A | C | A | D | A | A |
| Example 3 | | | | | | | |
| Comparative | C | A | B | A | D | A | A |
| Example 4 | | | | | | | |
| Comparative | Paper wound around a fixing roller. In addition, a | | | | | | |
| Example 5 | developer leaked from a developing device. | | | | | | |
| Comparative | B | C | D | D | A | B | C |
| Example 6 | | | | | | | |
| Comparative | B | C | D | D | A | B | C |
| Example 7 | | | | | | | |
| Comparative | D | B | B | A | B | A | C |
| Example 8 | | | | | | | |
| Comparative | No image could be printed. | | | | | | |
| Example 9 | | | | | | | |
| Comparative | D | A | A | A | A | B | C |
| Example 10 | | | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-22658, filed Feb. 1, 2008, which is hereby incorporated by reference herein in its entirety.

What is claimed is:

1. A two-component developer, comprising a magnetic carrier and a toner, wherein:
the magnetic carrier comprises a carrier containing resin-containing magnetic particles obtained by incorporating a resin into pores of porous magnetic core particles;
when a packed bulk density and a true density of the porous magnetic core particles are represented by ρ1 (g/cm³) and ρ2 (g/cm³), respectively, ρ1 is 0.80 or more and 2.40 or less, and ρ1/ρ2 is 0.20 or more and 0.42 or less;
the porous magnetic core particles have a specific resistance of 1.0×10³ Ω·cm or more and 5.0×10⁷ Ω·cm or less;
when a 50% particle diameter (D50) on a volume basis of the magnetic carrier is represented by D50, an average breaking strength of the magnetic carrier having a particle diameter of (D50−5 μm) or more and (D50+5 μm) or less is represented by P1 (MPa), and an average breaking strength of the magnetic carrier having a particle diameter of 10 μm or more and less than 20 μm is represented by P2 (MPa), P1 is 20 or more and 100 or less, and P2/P1 is 0.50 or more and 1.10 or less;
the toner has toner particles each containing at least a binder resin and a wax; and
the toner has a toner surface tension constant in a 45-vol % aqueous solution of methanol measured by a capillary suction time method of 3.0×10⁻⁶ kN/m or more and 1.0×10⁻⁴ kN/m or less.

2. A two-component developer according to claim 1, wherein the magnetic carrier has P2/P1 of 0.70 or more and 1.10 or less.

3. A two-component developer according to claim 1, wherein the magnetic carrier has D50 of 20 μm or more and 70 μm or less.

4. A two-component developer according to claim 1, wherein the magnetic carrier always has a dielectric loss tangent tan δ represented by a ratio of a dielectric loss index ∈″ to a dielectric constant ∈′ in a range of 0.0010 or more to 0.0450 or less in a frequency range of 1×10² Hz or more to 1×10⁴ Hz or less.

5. A two-component developer according to claim 1, wherein the porous magnetic core particles are each formed of a ferrite, and each contain an Mn oxide.

6. A two-component developer according to claim 1, wherein a surface of each of the resin-containing magnetic particles is coated with the resin incorporated into the pores.

7. A two-component developer according to claim 1, wherein the magnetic carrier has a specific resistance of 1.0×10⁷ Ω·cm or more and 1.0×10¹⁰ Ω·cm or less.

8. A replenishing developer for use in an image-forming method which includes at least the steps of: charging an electrostatic latent image bearing member; forming an electrostatic latent image on a surface of the electrostatic latent image bearing member; developing the electrostatic latent image with a two-component developer in a developing device to form a toner image; transferring the toner image onto a transfer material through or without through an intermediate transfer body; and fixing the transferred toner image to the transfer material, and in which the developing device is replenished with the replenishing developer in accordance with a reduction in toner concentration of the two-component developer in the developing device, and an excess magnetic carrier in the developing device is discharged from the developing device, the replenishing developer comprising a magnetic carrier and a toner at a compounding ratio of 2 parts by mass or more and 50 parts by mass or less with respect to 1 part by mass of the magnetic carrier, wherein:
the magnetic carrier comprises a carrier containing resin-containing magnetic particles obtained by incorporating a resin into pores of porous magnetic core particles;
when a packed bulk density and a true density of the porous magnetic core particles are represented by ρ1 (g/cm³) and ρ2 (g/cm³), respectively, ρ1 is 0.80 or more and 2.40 or less, and ρ1/ρ2 is 0.20 or more and 0.42 or less;
the porous magnetic core particles have a specific resistance of 1.0×10³ Ω·cm or more and 5.0×10⁷ Ω·cm or less;
when a 50% particle diameter (D50) on a volume basis of the magnetic carrier is represented by D50, an average breaking strength of the magnetic carrier having a particle diameter of (D50−5 μm) or more and (D50+5 μm) or less is represented by P1 (MPa), and an average breaking strength of the magnetic carrier having a particle diameter of 10 μm or more and less than 20 μm is represented by P2 (MPa), P1 is 20 or more and 100 or less, and P2/P1 is 0.50 or more and 1.10 or less;
the toner has toner particles each containing at least a binder resin and a wax; and
the toner has a toner surface tension constant in a 45-vol % aqueous solution of methanol measured by a capillary suction time method of 3.0×10⁻⁶ kN/m or more and 1.0×10⁻⁴ kN/m or less.

9. An image-forming method, comprising at least the steps of: charging an electrostatic latent image bearing member; forming an electrostatic latent image on a surface of the electrostatic latent image bearing member; developing the electrostatic latent image with a two-component developer in a developing device to form a toner image; transferring the toner image onto a transfer material through or without through an intermediate transfer body; and fixing the transferred toner image to the transfer material, in which the developing device is replenished with a replenishing developer in accordance with a reduction in toner concentration of the two-component developer in the developing device, and an excess magnetic carrier in the developing device is discharged from the developing device, wherein:
the two-component developer and the replenishing developer each comprise a developer containing a magnetic carrier and a toner;
the replenishing developer contains the toner at a compounding ratio of 2 parts by mass or more and 50 parts by mass or less with respect to 1 part by mass of the magnetic carrier;
the magnetic carrier comprises a carrier containing resin-containing magnetic particles obtained by incorporating a resin into pores of porous magnetic core particles;
when a packed bulk density and a true density of the porous magnetic core particles are represented by ρ1 (g/cm³) and ρ2 (g/cm³), respectively, ρ1 is 0.80 or more and 2.40 or less, and ρ1/ρ2 is 0.20 or more and 0.42 or less;
the porous magnetic core particles have a specific resistance of 1.0×10³ Ω·cm or more and 5.0×10⁷ Ω·cm or less;
when a 50% particle diameter (D50) on a volume basis of the magnetic carrier is represented by D50, an average breaking strength of the magnetic carrier having a particle diameter of (D50−5 μm) or more and (D50+5 μm) or less is represented by P1 (MPa), and an average breaking strength of the magnetic carrier having a particle diameter of 10 μm or more and less than 20 μm is represented by P2 (MPa), P1 is 20 or more and 100 or less, and P2/P1 is 0.50 or more and 1.10 or less;
the toner has toner particles each containing at least a binder resin and a wax; and
the toner has a toner surface tension constant in a 45-vol % aqueous solution of methanol measured by a capillary suction time method of 3.0×10⁻⁶ kN/m or more and 1.0×10⁻⁴ kN/m or less.
